(19) United States
(12) Patent Application Publication
(10) Pub. No.: US 2007/0214173 A1
(43) Pub. Date: Sep. 13, 2007

(54) Program, method, and apparatus for supporting creation of business process model diagram

(75) Inventors: Kyoko Ohashi, Kawasaki (JP); Junji Shimaoka, Kawasaki (JP); Kouji Yamamoto, Kawasaki (JP); Rieko Yamamoto, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/726,384

(22) Filed: Mar. 21, 2007

Related U.S. Application Data
(63) Continuation of application No. PCT/JP04/13942, filed on Sep. 24, 2004.

(51) Int. Cl. G06F 7/00

(52) U.S. Cl. 707/102

(57) ABSTRACT

A program, method and apparatus for supporting creation of business process model diagram which are capable of realizing verifying a business process model created by using general-purpose drawing software and notifying an operation modeler of defective parts. A model structure analysis means analyzes a business process model diagram, determines the type of each constituent element forming the business process model diagram, and creates a model structure representing relations between the constituent elements. Then a verification means selects at least part of the constituent elements as a verification target element, extracts a verification rule relevant to the type of the selected verification target element, out of preset verification rules describing conditions that the constituent elements of the business process model diagram should satisfy, and verifies whether the selected verification target element satisfies the extracted verification rule. Then if the verification means obtains a dissatisfaction result, a verification result display means displays a position to be operated to resolve the dissatisfaction of the verification target element with the verification rule.

This application is a continuing application, filed under 35 U.S.C. §111(a), of International Application PCT/JP2004/013942 filed Sep. 24, 2004.

### BACKGROUND OF THE INVENTION

(1) Field of the Invention

This invention relates to a program, method, and apparatus for supporting creation of business process model diagrams, which realize verifying validity of a diagram created to represent a business process model, and more particularly to a program, method, and apparatus for supporting creation of business process model diagrams, which realize displaying verification results to users in an easy-to-understand manner.

(2) Description of the Related Art

At an initial stage of software development, diagrams of business process model are created by modeling customer requirements. The diagrams of business process model comprise a business process flow diagram and a data structure diagram. The business process flow diagram represents by graphics and letters a procedure of operations to be performed and information to be given between the operations. The data structure diagram represents relations between data. By previously creating such diagrams of business process model, a user and a system developer are able to accurately communicate their understandings with each other.

To create diagrams of business process model, general-purpose drawing software or dedicated software for drawing special diagrams such as diagrams of business process model is used. For the case of drawing diagrams of business process model, the general-purpose drawing software and the dedicated software have following different features.

Use of the general-purpose drawing software has following advantages.

Software that a model creator normally uses or inexpensive software can be used.

New skills for operating software are not required, unlike dedicated software.

However, the general-purpose drawing software has following problems.

A business process flow diagram may include a line that is not accurately connected with figures representing business processes, the line representing a transition between the business processes.

An operation flow may include a conditional branch without guard conditions.

There is no function for detecting errors in an operation flow. Even if a line representing a transition connects figures that should not be connected to each other in a business process flow diagram, this error cannot be detected.

Even if a business process is written beyond a corresponding partition (a rectangular in a diagram), this error cannot be detected.

On the other hand, the dedicated software is called a modeling editor and is a dedicated editor for creating models such as diagrams of business process model. Therefore, the dedicated software has not only an editing function using the formats of business process flow diagrams and data structure diagrams, but also a function of locally saving the structure information of models and a function of representing the structure of a model in a tree structure and editing the tree structure representing the structure.

The modeling editor analyzes a created business process model diagram to represent the structure of the model in a tree structure. At this time, if such an error that a transition is not accurately connected with a business process exists, the analysis of the business process model results in failure. Therefore, some modeling editors have a function of verifying validly of a model.

For example, in the case where an error is detected in a business process model diagram, a conventional verification function shows the IDs of elements of the model and error details to a model creator, so as to support the operation modeler in correction (for example, refer to Japanese Unexamined Patent Publication No. 2002-133051 (FIG. 8)).

However, conventional dedicated software only shows existence of verification errors and therefore has a drawback that parts causing the errors are not easy to specify.

For example, a user may not name some of model structure information. In more detail, out of model structure elements appearing in a business process flow diagram, the user does not give names to transition, decision/merge node, fork/join node, and so on. Many transitions and decision nodes may appear in one operation flow. Therefore, if a verification error occurs in a transition or a decision node, it is hard for the user to check the diagram with eyes to decide which element out of many elements has caused the verification error. The patent literature 1 shows a user the identifiers of model elements and elements of a diagram that have caused verification errors. However, it is hard to specify figures or the like corresponding to the identifiers from a business process flow diagram.

Further, the more complicated operation a business process model represents, the bigger scale a business process flow diagram has. If an error is detected, it is very hard to specify a part that should be corrected.

Furthermore, normally, an operation modeler knows operations very well but is not skilled in a tool. Therefore, the operation modeler may not know how to correct errors, only from error messages. Therefore, it is desirable that the operation modeler creates a business process flow diagram by using a drawing function incorporated in software that he/she usually uses.

However, general-purpose drawing software does not create meaning of figures forming a business process flow diagram, on an operation flow. Therefore, it is difficult to verify whether a business process flow diagram created by such general-purpose drawing software is appropriate for representing a business process model.

### SUMMARY OF THE INVENTION

This invention has been made in view of the foregoing and intends to provide a program for supporting creation of business process model diagrams, a method for supporting creation of business process model diagrams, and an apparatus for supporting creation of business process model diagrams, which are capable of verifying a business process model created by general-purpose drawing software and notifying an operation modeler of defective parts.

To solve the above problems, the present invention provides a computer-readable recording medium containing a business process model diagram creation supporting program for supporting creation of a business process model diagram representing a structure of user's business process model. The program causing a computer to function as: a model structure analysis unit for analyzing the business process model diagram where figures and lines are used as constituent elements, determining a type of each constituent element forming the business process model diagram, and creating a model structure representing relations between the constituent elements; a verification unit for selecting at least part of the constituent elements as a verification target element, extracting a verification rule relevant to the type of the verification target element selected, out of preset verification rules describing conditions that the constituent elements of the business process model diagram should satisfy, and verifying whether the verification target element selected satisfies the extracted verification rule; and a verification result display unit for displaying a position to be operated to resolve dissatisfaction of the verification target element with the verification rule in a case where the verification unit obtains a dissatisfaction result.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of the present invention that is implemented in one embodiment.

FIG. 2 is a view showing an example hardware configuration of a computer to be used in this embodiment.

FIG. 3 is a functional block diagram according to the first embodiment.

FIG. 4 is a business process flow diagram.

FIG. 5 is a data structure diagram.

FIG. 6 is a view showing an example of structure definition information.

FIG. 7 is a view showing an example business process flow diagram using terminals.

FIG. 8 is a view showing an example model structure display window.

FIG. 9 is a UML class diagram showing a part of model structure definitions.

FIG. 10 is a view showing an example of model structure information.

FIG. 11 is a view showing an example of verification rule-measures information.

FIG. 12 is a sequence diagram showing a procedure of a business process model verification process according to the first embodiment.

FIG. 13 is a view showing an example verification result list.

FIG. 14 is a sequence diagram showing a procedure of displaying a verification error part on a model structure display window.

FIG. 15 is a view showing an example screen displaying verification results according to the first embodiment.

FIG. 16 is a functional block diagram according to the second embodiment.

FIG. 17 is a view showing an example of verification rule-measures information according to the second embodiment.

FIG. 18 is a sequence diagram showing a procedure of displaying a verification error part on an operation flow display screen.

FIG. 19 is a view showing an example screen showing verification results according to the second embodiment.

FIG. 20 is a functional block diagram according to the third embodiment.

FIG. 21 is a sequence diagram showing a procedure of a business process model verification process according to the third embodiment.

FIG. 22 is a functional block diagram according to the fourth embodiment.

FIG. 23 is a view showing an example of diagram information.

FIG. 24 is a sequence diagram showing a procedure of a business process model verification process according to the forth embodiment.

FIG. 25 is a functional block diagram according to the fifth embodiment.

FIG. 26 is a view showing an example data structure of verification rule-measures information.

FIG. 27 is a view showing an example verification result list with timestamps given thereto.

FIG. 28 is a view showing a first example of a progress display screen.

FIG. 29 is a view showing a second example of the progress display screen.

FIG. 30 is a view showing a third example of the progress display screen.

FIG. 31 is a functional block diagram according to the sixth embodiment.

FIG. 32 is a view showing an example of verification rule-measures information with verification timing set therein.

FIG. 33 is a view showing an example verification rule that is desirably set.

FIG. 34 is a view showing an example of verification rule-measures information with model patterns before and after measures registered therein.

### DESCRIPTION OF THE PREFERRED EMBODIMENTS

Hereinafter, preferred embodiments will be described with reference to accompanying drawings.

The invention that is implemented in the embodiments will be first outlined and then the embodiments will be specifically described.

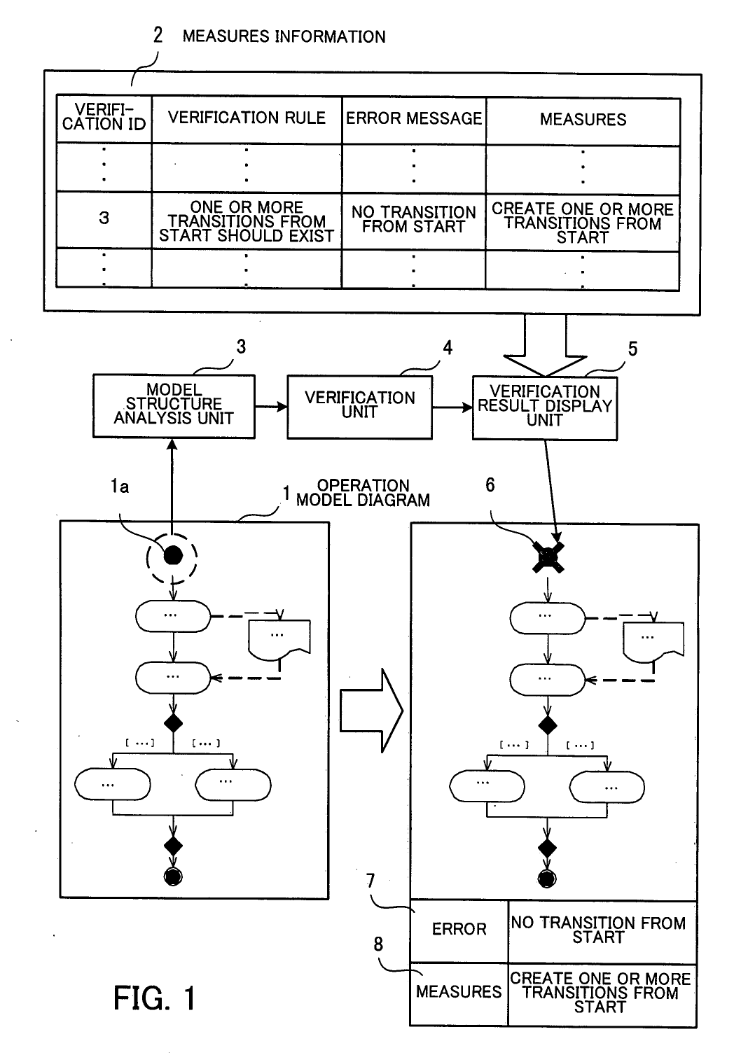

FIG. 1 is a conceptual view of the invention that is implemented in one embodiment. This invention provides measures information 2, a model structure analysis unit 3, a verification unit 4, and a verification result display unit 5, in order to support creation of a business process model diagram 1 representing the structure of user's business process model.

The measures information 2 previously registered contains, in association with verification rules, error messages and measures that are used for the case where constituent elements that do not satisfy the verification rules are detected.

The model structure analysis unit 3 analyzes the business process model diagram 1 where figures and lines are used as the constituent elements. Then, the model structure analysis unit 3 determines the type of each constituent element forming the business process model diagram 1, and creates a model structure representing relations between the constituent elements. For example, correspondences between figures forming the business process model diagram 1 and the types of elements in the model structure are defined in advance. Then, by referring to the defined correspondences, the model structure analysis unit 3 determines the type of each constituent element in the business process model diagram 1.

The verification unit 4 selects at least part of the constituent elements as a verification target element 1a. For example, the verification unit 4 takes a user-designated constituent element as a verification target element 1a. Then, the verification unit 4 extracts a verification rule relevant to the type of the selected verification target element 1a, out of the preset verification rules describing conditions that the constituent elements of the business process model diagram 1 should satisfy. For example, if the type of the verification target element 1a is “start”, a verification rule relevant to start is extracted. Then the verification unit 4 verifies whether the selected verification target element 1a satisfies the extracted verification rule.

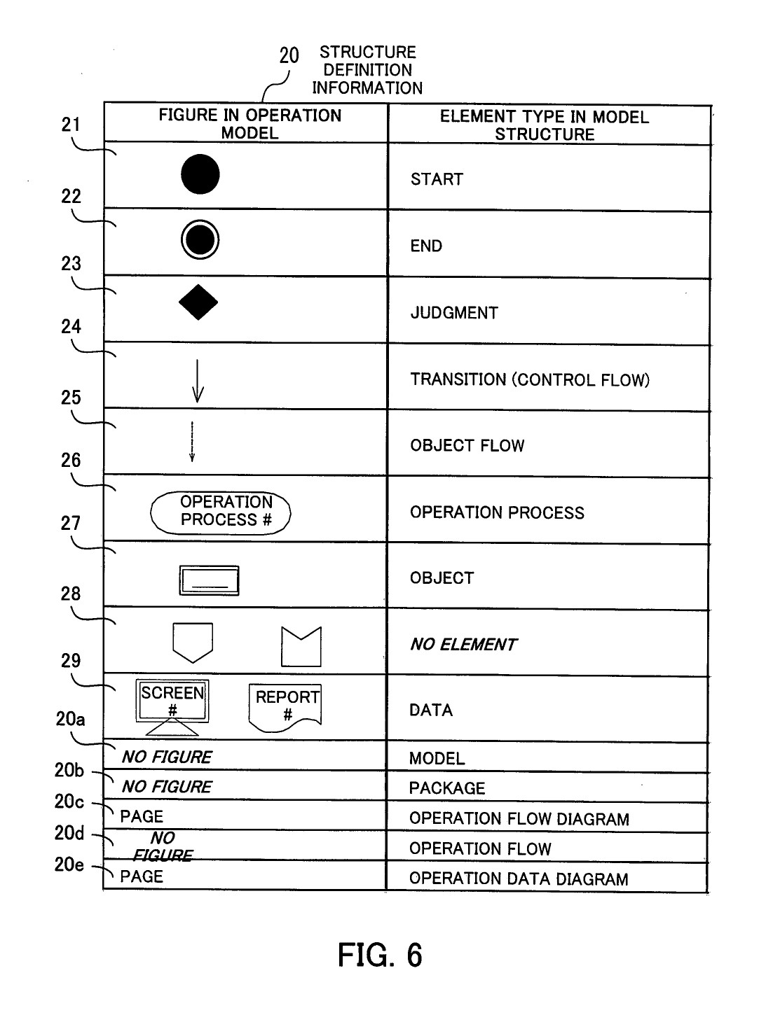

In the case where the verification unit 4 obtains a dissatisfaction result (a verification error), the verification result display unit 5 displays a position to be operated to resolve the dissatisfaction of the verification target element 1a with the verification rule. For example, the verification result display unit 5 displays a FIG. 6 that shows a defective position, at an error part on the business process model diagram 1. In this connection, the error part can be specified by the identifier of the verification target element. In addition, the verification result display unit 5 refers to the measures information 2 in order to display an error message 7 and measures 8 which are associated with the verification rule determined as being not satisfied.

By causing a computer to execute such a business process model diagram creation supporting program, first the model structure analysis unit 3 analyzes the business process model diagram 1, determines the type of each constituent element forming the business process model diagram 1, and creates the model structure representing the relations between the constituent elements.

Then, the verification unit 4 selects at least part of the constituent elements as a verification target element 1a. Then, the verification unit 4 extracts a verification rule relevant to the type of the selected verification target element 1a, out of the preset verification rules describing conditions that the constituent elements of the business process model diagram 1 should satisfy. Then the verification unit 4 verifies whether the selected verification target element 1a satisfies the extracted verification rule.

Then, if the verification unit 4 obtains a dissatisfaction result, the verification result display unit 5 displays a FIG. 6 that shows a position (an error part) to be operated to resolve the dissatisfaction of the verification target element 1a with the verification rule, an error message 7, and measures 8.

For example, in the example of FIG. 1, the verification target element 1a represents “start” in the model structure. Then, a verification rule defining that “one or more transitions from start should exist” is applied. In the business process model diagram 1, a line that represents a transition from the verification target element 1a is not connected to the verification target element 1a. Therefore, this verification error is detected under the applied verification rule. As a result, a cross FIG. 6 is displayed on the verification target element 1a, and also an error message 7 and measures 8 are displayed.

As described above, by employing a technique for obtaining a position for showing a model element or a diagram element causing a verification error, based on the ID (identifier) of the error element from a model structure editor or a diagram editor, a diagram having a verification error and further a position causing the verification error in the diagram can be specified. By marking the FIG. 6 on the position, the verification error position can be shown to a user in an easy-to-understand manner.

Further, information on (1) how to correct verification errors and on (2) in what situation the verification errors occur is collected when a user meets with the verification errors, and the information is provided to the user as measures together with error messages. This reduces user's burden of correction and improves usability.

Furthermore, by displaying measures 8 together with an error message 7, the user can easily correct the business process model diagram 1.

It should be noted that an error part can be displayed on the business process model diagram 1 or displayed on a tree structure diagram representing a model structure. It can be previously specified which diagram is to be displayed, for each verification rule. By displaying an error part on the tree structure representing the model structure, an element to be corrected can be clearly shown even the element is an error part that does not appear on the business process model diagram 1, such as a transition in a business process flow diagram or information indicating relations in a data structure diagram.

Further, a verification process can be automatically performed at preset timing. For example, the verification can be performed when a file storing a business process model is saved or closed. For example, even while the business process model diagram 1 is edited, the verification process can be performed serially under important verification rules. Thereby, when a critical error occurs, this error can be corrected immediately even during editing. In addition, as to verification rules that are often to be applied during editing, the verification process may be performed when a file is closed, which can prevent an error message from being displayed excessively. As a result, the operation modeler can improve editing efficiency.

In addition, verification rules that are directly applied to data of the business process model diagram 1 can be executed. Thereby an error that can be detected only from the business process model diagram 1 can be detected.

Still further, by setting an importance level of an error for each verification rule, the importance level can be displayed together with an error message when a verification error occurs. For example, the user can identify that a verification error is critical and requires correction or that the verification error requires only his/her recognition, based on the importance level of the verification error.

Still further, statistical information indicating a progress of creation of business process model can be displayed. Thereby the user can easily know the progress of creation operation of the business process model diagram 1.

Still further, verification rules can be registered according to commands input from the user. Alternatively, by previously registering a plurality of verification rules, only verification rules selected by the user can be used in a verification process. By doing so, the verification rules can be dynamically and easily selected for each project.

Still further, when a proposed correction of the business process model diagram 1 is displayed on a screen and the user accepts it, the business process model diagram 1 can be corrected in accordance with the proposed correction. By showing a proposed correction of the business process model and correcting the model in response to an acceptance response to the proposed correction, user's burden of correction can be reduced.

Now, the embodiments will be described in detail.

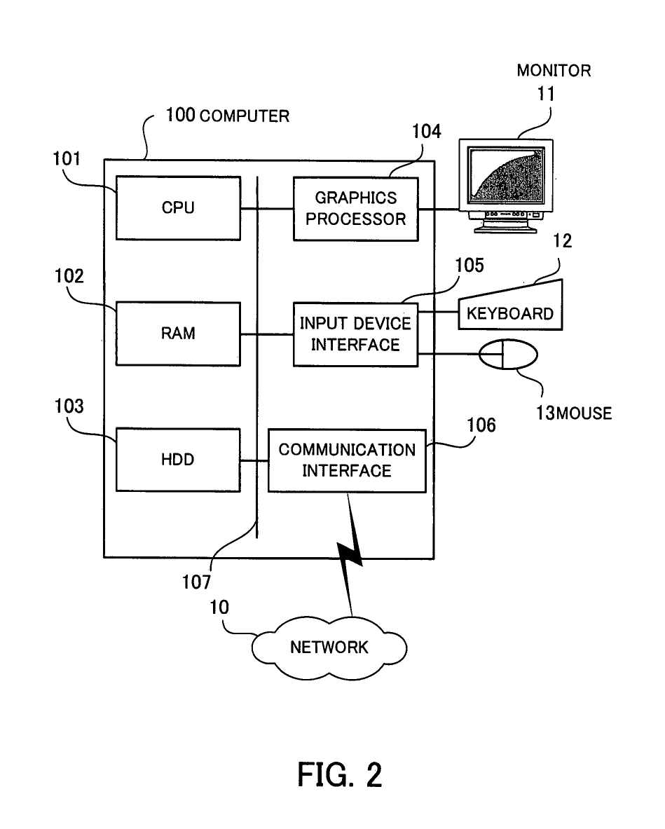

FIG. 2 is a view showing an example hardware configuration of a computer that is used in the embodiments. The computer 100 is entirely controlled by a CPU (Central Processing Unit) 101. Connected to the CPU 101 via a bus 107 are a RAM (Random Access Memory) 102, a hard disk drive (HDD) 103, a graphics processor 104, an input device interface 105, and a communication interface 106.

The RAM 102 temporarily stores part of an OS (Operating System) program and application programs to be executed by the CPU 101. In addition, the RAM 102 stores various kinds of data required for CPU processing. The HDD 103 stores the OS and the application programs.

Connected to the graphics processor 104 is a monitor 11. The graphics processor 104 displays images on the screen of the monitor 11 under the control of the CPU 101. Connected to the input device interface 105 are a keyboard 12 and a mouse 13. The input device interface 105 transfers signals from the keyboard 12 and the mouse 13 to the CPU 101 via the bus 107.

The communication interface 106 is connected to a network 10. The communication interface 106 communicates data with another computer over the network 10.

With such a hardware configuration, the processing functions of the embodiments can be realized. Hereinafter, the embodiments of a business process flow diagram creation supporting apparatus to be realized on a computer shown in FIG. 2 will be described in detail.

### First Embodiment

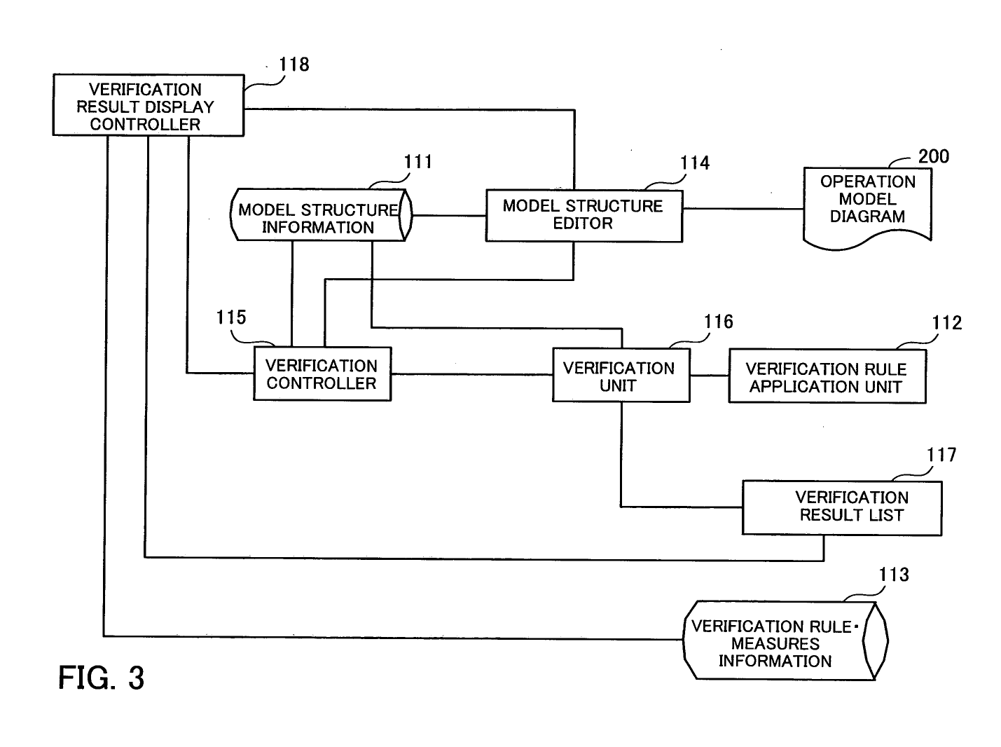

FIG. 3 is a functional block diagram according to the first embodiment. The business process flow diagram creation supporting apparatus comprises model structure information 111, a verification rule application unit 112, verification rule-measures information 113, a model structure editor 114, a verification controller 115, a verification unit 116, a verification result list 117, and a verification result display controller 118.

The model structure information 111 contains the structure information of a business process model diagram 200 drawn by a user. The model structure information 111 represents the structure of the business process model diagram 200 in a tree structure. It should be noted that the business process model diagram 200 includes a business process flow diagram and a data structure diagram.

The verification rule application unit 112 stores therein a plurality of verification rules relevant to elements (objects representing business processes and conditional branches, and so on.) forming the business process model diagram 200. For example, a verification rule defines that “guard conditions (conditions for transition to a branch destination) should be set for each branch destination in a conditional branch”.

The verification rule-measures information 113 contains error messages and effective information (measures) to correct errors, which are displayed to a user when the errors are detected by verification, in association with verification rules.

The model structure editor 114 edits the model structure based on the business process model diagram 200 drawn by the user. The constituent elements (nodes and so on) of the model structure are associated with the identifier numbers of their corresponding elements of the business process model diagram 200.

In addition, the model structure editor 114 accepts a specified part (verification part) to be verified, out of the model structure in response to commands input from the user. Then, when the model structure editor 114 receives a verification instruction from the user, it gives the specified verification part and the verification request to the verification controller 115. In this connection, the verification part is specified by using an identifier number that is set for each element in the business process model diagram 200. On the other hand, when the model structure editor 114 receives information of a verification error part from the verification result display controller 118, it displays at the part a figure or the like that shows a verification error.

When the verification controller 115 receives the verification request, it gives the verification unit 116 information identifying the verification part specified by the model structure editor 114, and instructs it to verify the verification target. On the other hand, when the verification controller 115 receives a notice of completion of the verification process from the verification unit 116, it instructs the verification result display controller 118 to display a verification result.

The verification unit 116 acquires the verification target from the model structure information 111 based on the information identifying the verification part given from the verification controller 115. Then the verification unit 116 instructs the verification rule application unit 112 to apply a verification rule, to thereby verify whether the acquired verification target satisfies the verification rule. Further, the verification unit 116 registers its verification result in the verification result list 117. When the verification unit 116 completes the verification process for the verification target, it notifies the verification controller 115 of this completion.

The verification result list 117 contains verification results output from the verification unit 116.

When instructed to display a verification result from the verification controller 115; the verification result display controller 118 acquires verification results from the verification result list 117, and extracts the verification error results of the verification process. In addition, the verification result display controller 118 refers to the verification rule-measures information 113 to detect parts causing the verification errors, error messages, and measures for the verification errors. Then the verification result display controller 118 displays the error messages and the measures for the verification errors as a verification result, and notifies the model structure editor 114 of the parts causing the verification errors. A verification error part is specified by the identifier number of a verified element, for example.

Now the contents of the business process model diagram 200 will be described. The business process model diagram 200 comprises a business process flow diagram and a data structure diagram.

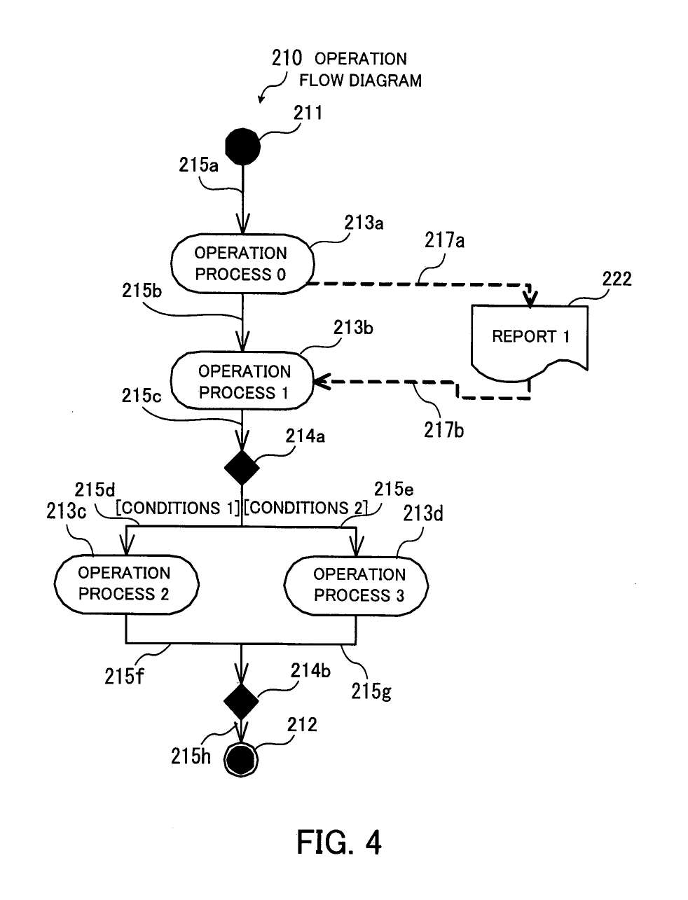

FIG. 4 is a business process flow diagram. The business process flow diagram 210 comprises business processes 213a, 213b, 213c, and 213d, branches 214a and 214b, and report 222, from start 211 to end 212.

The start 211, end 212, business processes 213a, 213b, 213c, and 213d, and branches 214a and 214b are connected with transition lines 215a to 215h. The report 222 is connected to the business processes 213a and 213b with input/output lines 217a and 217b.

The start 211 represents the start position of the operation flow. The end 212 represents the end position of the operation flow. The business processes 213a, 213b, 213c, and 213d represent operations to be performed in the operation flow. The branches 214a and 214b represent branches of business processes under conditional branches.

The transition lines 215a to 215h represent transitions between the business processes. The transition lines 215a to 215h show transition sources and transition destinations by arrows. In this connection, in the transition lines 215d and 215e which takes the branch 214 as a transition source, conditions for corresponding transitions are set.

The input/output lines 217a and 217b show data to be output from a business process and data to be input to a business process. Specifically, the input/output line 217a indicates that a report indicated by the report 222 is output by performing an operation indicated by the business process 213a. In addition, the input/output line 217b indicates that a report indicated by the report 222 is input to a business process indicated by the business process 213b.

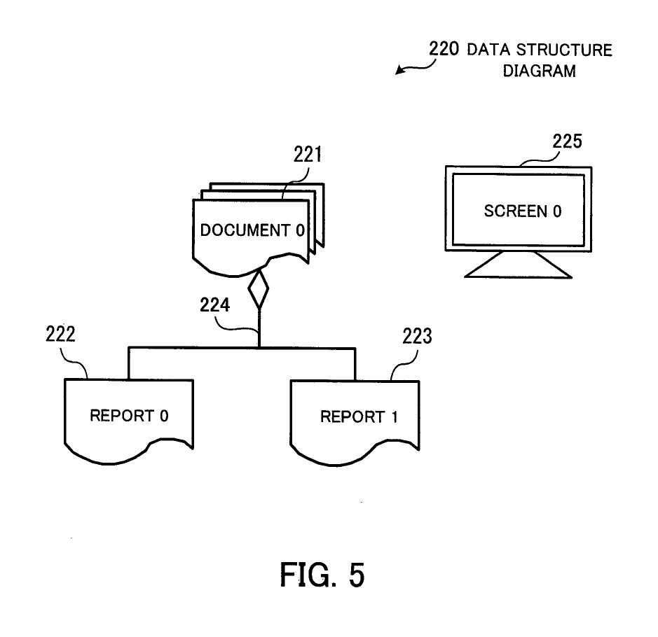

FIG. 5 is a data structure diagram. In the data structure diagram 220, document 221, reports 222 and 223 and a screen 225 represent data that is included in the business process model. In addition, relations between the document 221 and the reports 222 and 223 are specified by a line 224.

The business process model diagram 220 including the business process flow diagram 210 shown in FIG. 4 and the data structure diagram 220 shown in FIG. 5 can be edited by the model structure editor 114. The model structure editor 114 displays the model structure in a tree structure on a screen.

When the business process model diagram 200 having the contents shown in FIG. 4 and FIG. 5 is input to the model structure editor 114, the model structure editor 114 detects the model structure. Specifically, the model structure editor 114 previously has structure definition information defining correspondences between figures forming the business process flow diagram 210 and the data structure diagram 220, and elements forming the model structure. The model structure editor 114 analyzes the structure of the received business process model diagram 200 based on the structure definition information.

FIG. 6 is a view showing an example of structure definition information. The structure definition information 20 shows correspondences between figures in the business process model and element types in the model structure.

A first correspondence 21 indicates that a black dot in the business process model corresponds to the start in the model structure. A correspondence 22 indicates that a double circle (black inside) in the business process model corresponds to the end in the model structure. A correspondence 23 indicates that a black rhomboid in the business process model corresponds to a decision/merge node in the model structure.

A correspondence 24 indicates a solid arrow in the business process model corresponds to a transition (control flow) in the model structure. A correspondence 25 indicates that a input/output line in the business process model corresponds to an object flow in the model structure.

A correspondence 26 indicates that a ring figure displaying “business process” inside in the business process model corresponds to a business process in the model structure. A correspondence 27 indicates that a double square in the business process model corresponds to an object in the model structure.

A correspondence 28 indicates that two types of figures representing “terminal” in the business process model do not correspond to any element type in the model structure. A correspondence 29 indicates that a figure displaying “screen” inside and a figure displaying “report” inside in the business process model correspond to data in the model structure.

A correspondence 20a indicates that there is no figure in the business process model corresponding to a model in the model structure. A correspondence 20b indicates that there is no figure in the business process model corresponding to a package in the model structure.

A correspondence 20c indicates that one page forming the business process model corresponds to a business process flow diagram in the model structure. A correspondence 20d indicates that there is no figure in the business process model corresponding to an operation flow in the model structure. A correspondence 20e indicates that one page forming the business process model corresponds to an operation data diagram in the model structure.

As described above, out of the figures forming the business process model, some are reflected on the model structure information but some are not. The start, end, and business processes, which are included in the business process flow diagram, get involved in the structure of the operation flow, and are also reflected on the model structure information. On the other hand, “terminal” representing a connection between pages in the case where one operation flow is drawn on some diagram pages is out of relation to the structure of a model, and therefore are not reflected on the model structure information.

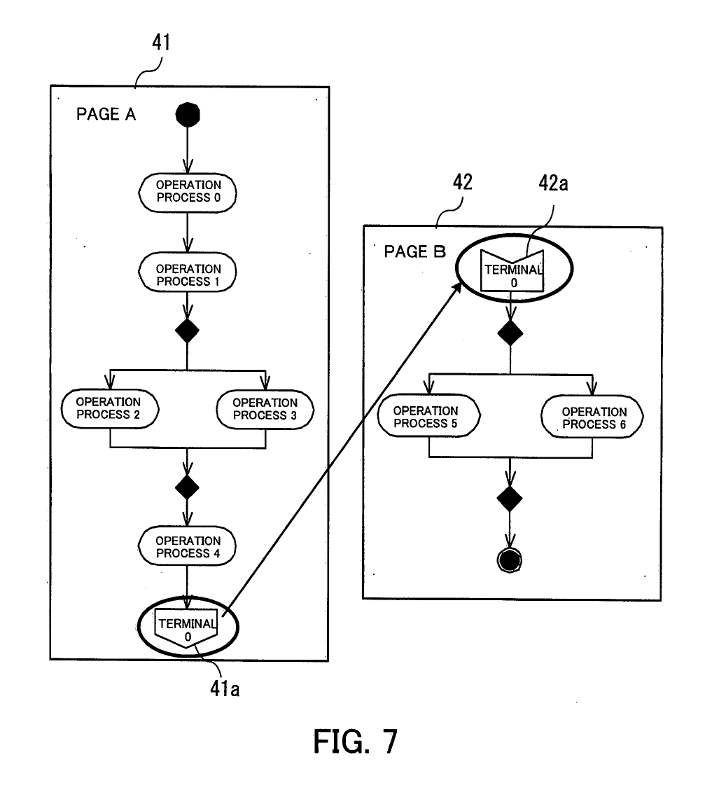

FIG. 7 is a view showing an example business process flow diagram using terminals. As shown in FIG. 7, one business process flow diagram may be created on some pages 41 and 42. In this case, a terminal 41a of page 41 is transited to a terminal 42a of page 42.

Such terminals 41a and 42a in the business process flow diagram indicate a connection between pages 41 and 42 only, and do not represent the structure of the business process model. Therefore, constituent elements in the business process model corresponding to the terminals 41a and 42a are not necessary.

Based on such structure definition information 20, the model structure editor 114 detects the model structure of the business process model diagram 200. The detected model structure is displayed in a tree structure on a screen.

At this time, to display properties of business processes and data (information on the business processes and data), a figure may be drawn at the upper part of a diagram page. In this case, the figure corresponds to the property of an object in the model structure information, and not to the object. Therefore, in the case where the model structure information 111 is displayed in a tree form, a node (icon) corresponding to data property does not exist.

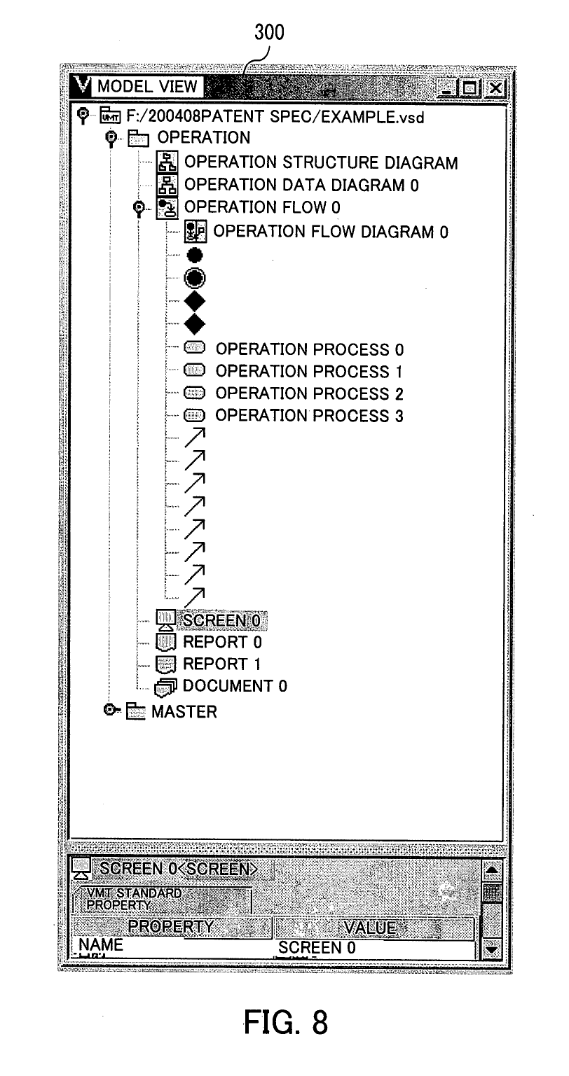

FIG. 8 is a view showing an example model structure display window. The model structure display window 300 displays the data structure of the business process model diagram 200 in a tree structure. The user can specify a verification target position on the model structure display window 300. For example, the user specifies an element as a verification target position with a mouse cursor or the like, and displays a menu screen (context menu, pull-down menu, or the like). Then the user selects a verification execution command appearing on the menu screen, to thereby make an instruction to perform verification on the verification target position.

In the case where data specified as a verification target position has a lower level structure, the data including the lower level position are to be verified.

The model structure information created from the business process model diagram 200 is created based on determined model structure definitions. The model structure definitions define which types of elements can be connected to which types of elements. The model structure definitions can be designed in a UML class diagram, for example.

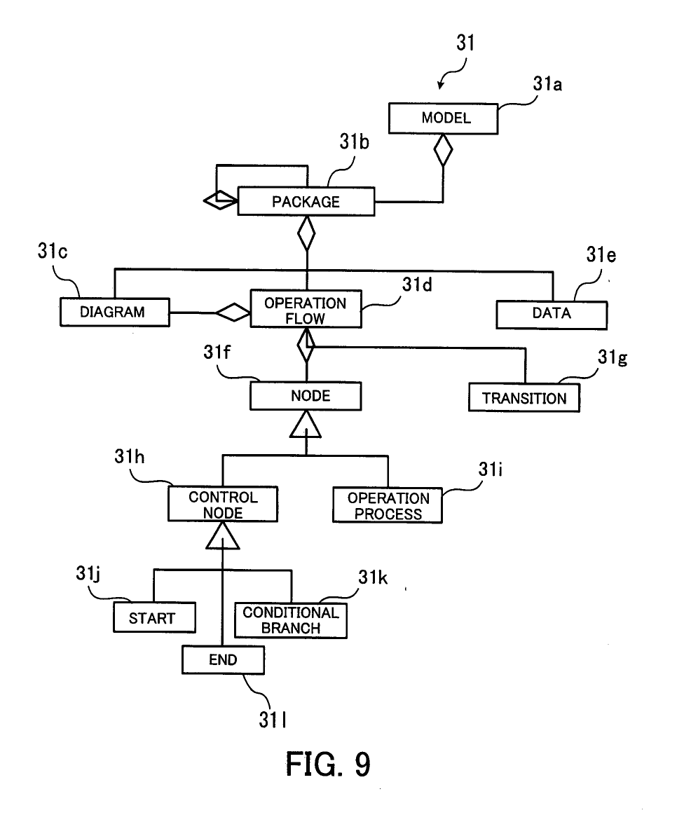

FIG. 9 is a UML class diagram showing a part of model structure definitions. Referring to FIG. 9, the model structure definitions 31 can be represented by using a class diagram. The model structure definitions 31 show connections between types 31a to 31l and types 31a to 31l. In accordance with such model structure definitions 31, model structure information is created.

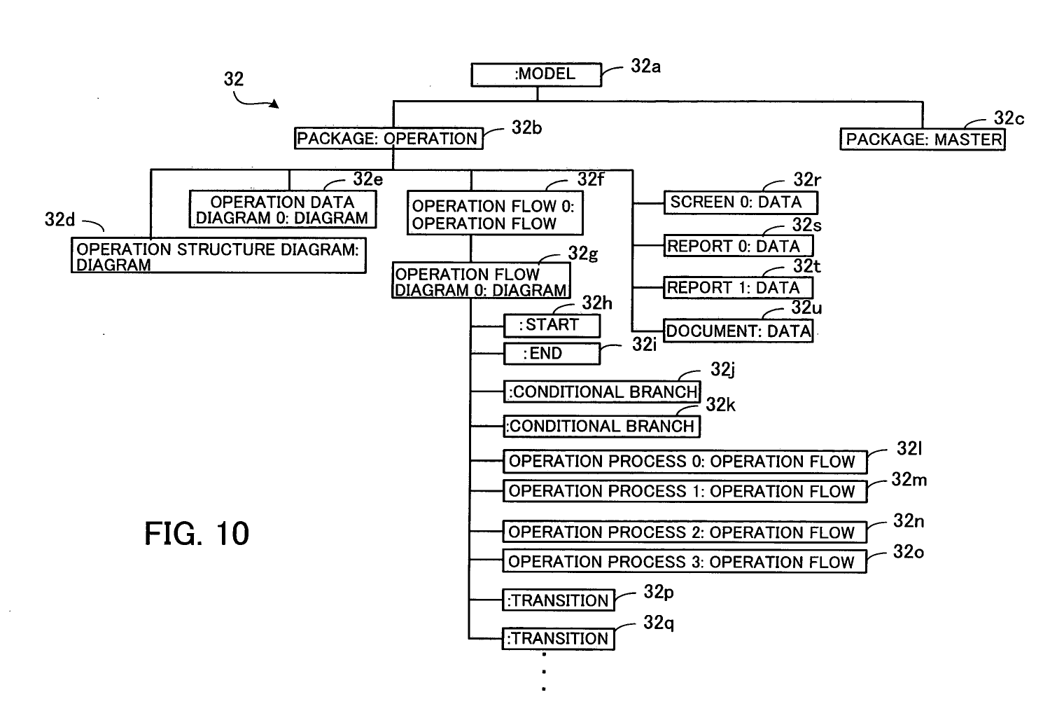

FIG. 10 is a view showing an example of model structure information. The model structure information 32 shows connections between model constituent elements 32a to 32u in a tree structure.

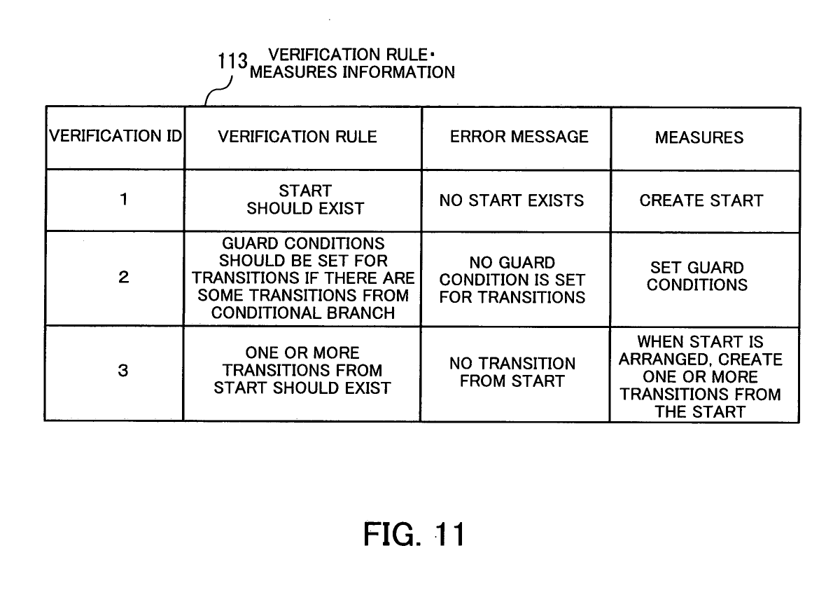

FIG. 11 is a view showing an example of verification rule-measures information. The verification rule-measures information 113 has columns for verification ID, verification rule, error message, and measures. Information arranged in a row is associated with each other.

The verification ID column contains identifier numbers set to sets of a verification rule, an error message, and measures. The verification rule column contains the contents of verification rules defined in the verification rule application unit 112. The error message column contains messages for the case where errors are detected by applying corresponding verification rules. The measures column contains measures for the case where errors are detected by applying corresponding verification rules.

For example, if a business process model is entirely verified under a verification rule of “start should exist” and as a result a figure corresponding to start does not exist, an error message is that “no start exists” and measures are that “create start”.

Now, processes to be performed by the business process flow diagram creation supporting apparatus according to the first embodiment will be described in detail.

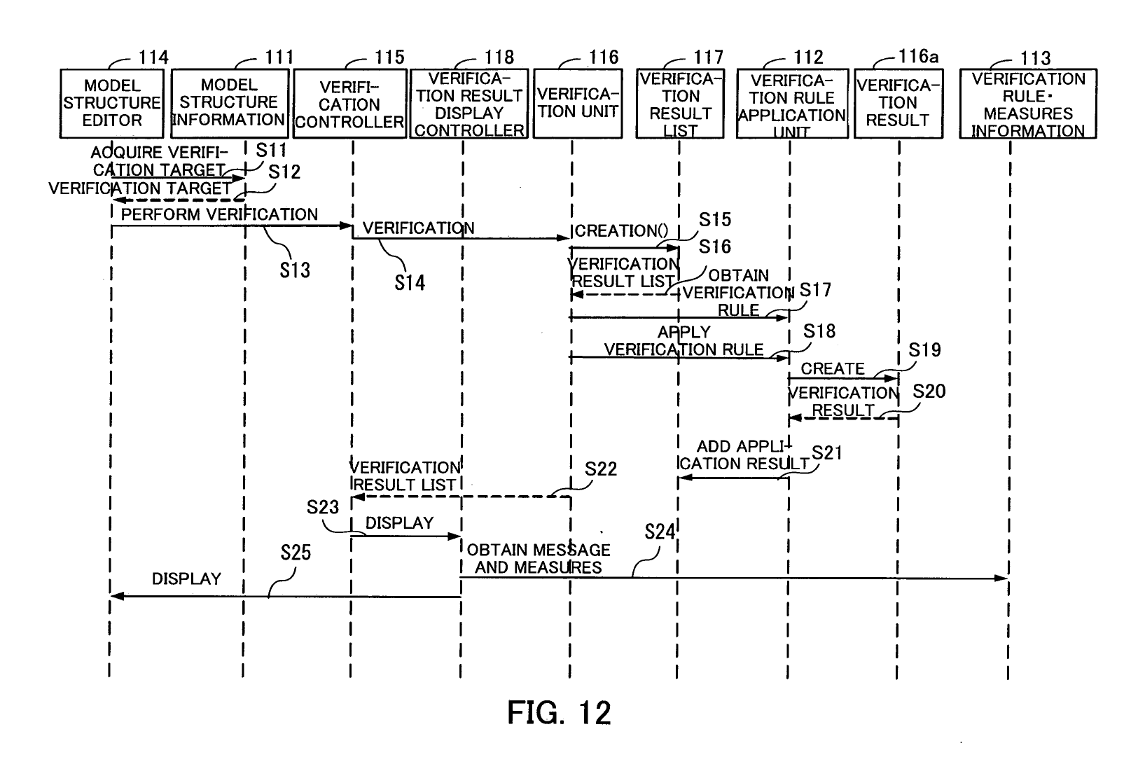

FIG. 12 is a sequence diagram showing a procedure of a business process model verification process according to the first embodiment. The model structure editor 114 specifies a part of the model structure to be verified (verification target position) from the model structure information 111, and performs a verification target acquisition process (step S11). The verification target position is determined in accordance with commands made by the user on the model structure displayed on a screen. The model structure to be verified is acquired from the model structure information 111 and is given to the model structure editor 114 (step S12).

Then, the model structure editor 114 instructs the verification controller 115 to perform verification on the verification target (step S13). The verification controller 115, which has being instructed to perform verification, gives the verification target to the verification unit 116, to thereby cause the verification unit 116 to perform the verification process (step S14).

The verification unit 116 creates a verification result list 117 having no contents (step S15). Thereby, the verification result list 117 is created on memory space being used by the verification unit 116 (step S16). Subsequent processes for data addition and so on to the verification result list 117 are performed on the memory space being used by the verification unit 116.

Then, the verification unit 116 accesses the verification rule application unit 112 to obtain a verification rule to be applied to the verification target (step S17). The verification unit 16 then gives the verification target and the verification result list to the verification rule application unit 112, and makes an instruction to apply the verification rule to the verification target (step S18).

In the case where the verification unit 116 acquires some verification rules, the verification unit 116 instructs the verification rule application unit 112 to apply all the verification rules. In addition, in the case where the received verification target has a lower level structure, the verification unit 116 outputs an instruction to apply all the verification rules to the verification targets including the lower level position.

The verification rule application unit 112 creates a verification result 130 by applying a verification rule to the verification target, every time when receiving an instruction to apply the verification rule from the verification unit 116 (step S19). The verification rule application unit 112 obtains the verification result 130 (step S20), and adds the result of application of the verification rule to the verification result list 117 (step S21). The application result to be added includes a verification target, a verification rule, and a verification result.

When the verification unit 116 completes application of all verification rules to all verification targets, the verification unit 116 gives the final verification result list 117 to the verification controller 115 (step S22). The verification controller 115 gives the verification result display controller 118 the verification result list for display (step S23).

The verification result display controller 118 displays a dialog of the verification result list. Then the verification result display controller 118 refers to the verification rule-measures information 113 to obtain a verification rule and measures for each verification result contained in the verification result list, and displays them in the dialog (step S24).

Further, the verification result display controller 118 specifies the ID of a verification target causing an error, and transmits an instruction to display the error part to the model structure editor 114 (step S25). The model structure editor 114 displays the verification target identified as an error by applying a verification rule, on a screen. For example, the model structure editor 114 displays a cross mark on the error part.

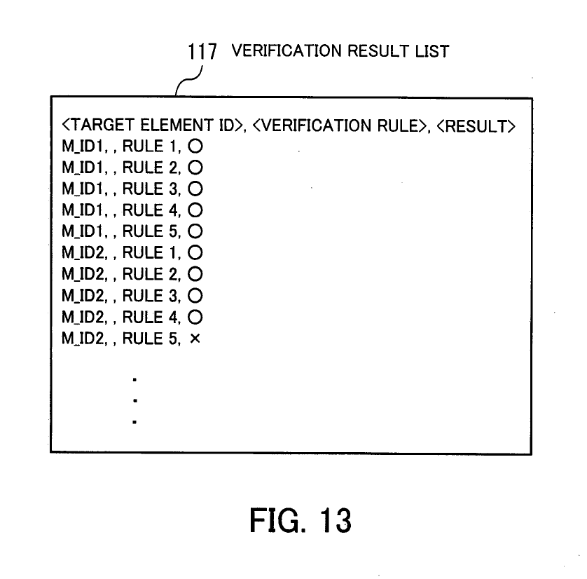

FIG. 13 is a view showing an example verification result list. The verification result list 117 contains verification results. A verification result comprises a set of a target element ID, a verification rule, and a result.

The target element ID is identifier information that uniquely identifies a figure (verification target) that was verified in the business process model. The verification rule is identifier information of a verification rule that was applied to the verification target. The result is information indicating whether or not the applied verification rule has been satisfied. If a verification rule has been satisfied, a circle mark “o” is set as a result, and if a verification rule has not been satisfied (verification error), a cross mark “x” is set as a result.

As described above, the model structure is verified, and if a verification result list contains an error, the error part is displayed together with measures for the error on the monitor screen.

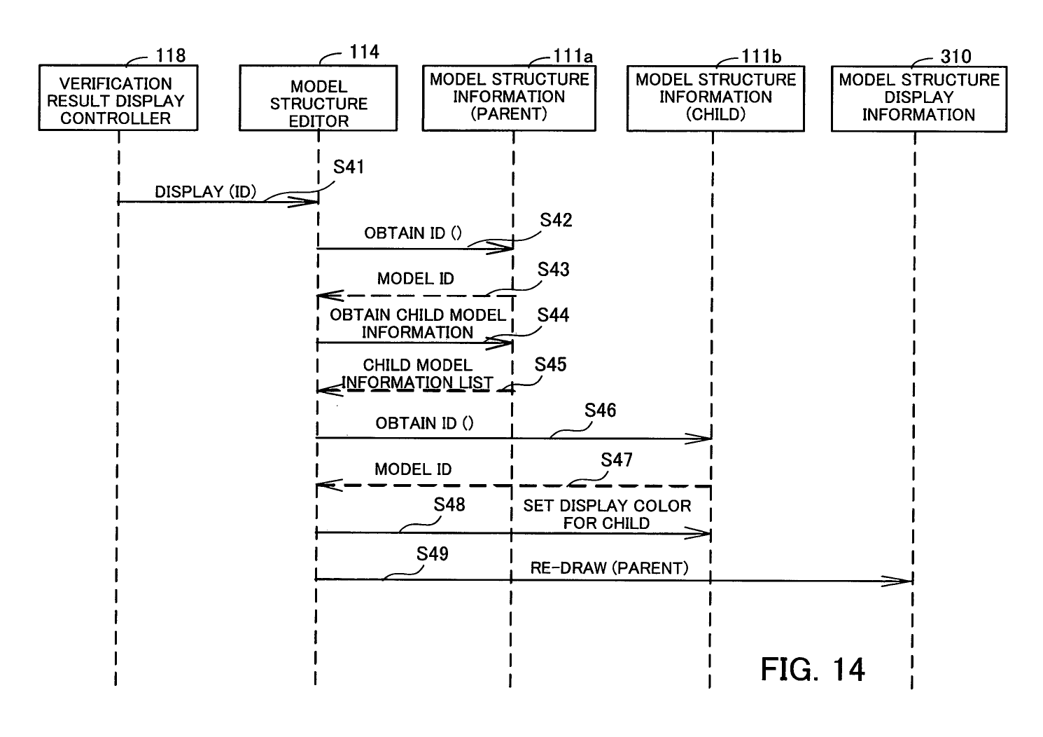

FIG. 14 is a sequence diagram showing a procedure of displaying a verification error part on the model structure display window.

First, the verification result display controller 118 outputs to the model structure editor 114 a display request specifying the ID of an element causing a verification error (step S41). The model structure editor 114 accesses parent model structure information 111a to obtain the ID of a model (step S42). Thereby, the model structure editor 114 obtains the ID of the model from the model structure information 111a (step S43). Then, the model structure editor 114 compares the ID given in the display request with the model ID. In this example, it is assumed that the IDs do not match.

Then the model structure editor 114 accesses the parent model structure information 111a to obtain child (lower level) model information (step S44). Thereby the model structure editor 114 obtains a child model information list from the model structure information 111a (step S45).

Further, the model structure editor 114 refers to the child model structure information 111b to obtain the ID of a model (step S46). Thereby the model structure editor 114 obtains the ID of the model from the model structure information 111a (step S47). Then the model structure editor 114 compares the ID given in the display request with the model ID. In this example, it is assumed that the IDs match.

When the IDs match, the model structure editor 114 sets a display color for highlighting display for the child model structure information 111b. Then the model structure editor 114 draws the model structure display information 310 relating to the parent model structure information 111a to be displayed on the model structure display window 300 again (step S49). In this example, a highlighting display color is set for the lower-level model structure of the parent, a color of a node causing the verification error is changed to the highlighting display color.

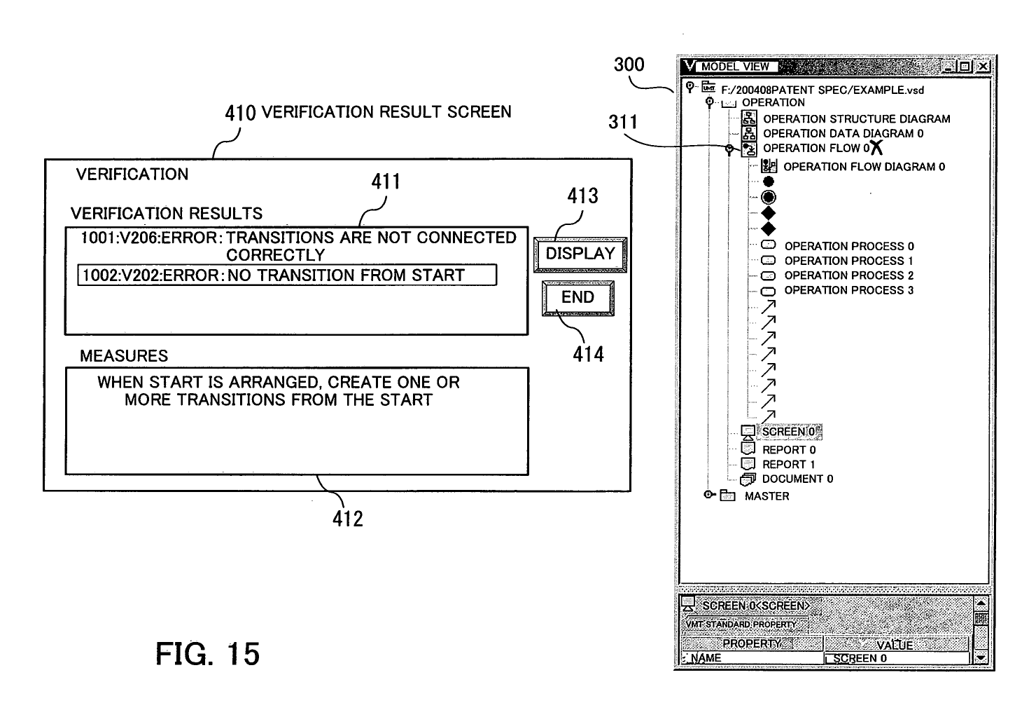

FIG. 15 is a view showing an example screen displaying verification results according to the first embodiment. When the verification process is completed, the verification result screen 410 is displayed on the side of the model structure display window 300.

The verification result screen 410 has a verification result display area 411, a measures display area 412, a display button 413, and an end bottom 414. The verification result display area 411 shows error messages obtained through the verification process that resulted in errors. The measures display area 412 shows measures for an error message selected on the verification result display area 411. The display button 413 is used for displaying measures for an error message selected from the verification results. The end button 414 is a button for closing the verification result screen 410.

In the case where an error is detected as a verification result, the node causing the error is highlighted in the model structure of the model structure display window 300. Referring to FIG. 15, a check mark is displayed at a node 311 causing an error.

As described above, by displaying measures for verification errors of the model structure and error parts on a screen, the user can easily correct the errors in the business process model diagram 200.

### Second Embodiment

Now, the second embodiment according to the present invention will be described. The second embodiment is provided by adding a function of editing the business process model diagram 200 to the first embodiment.

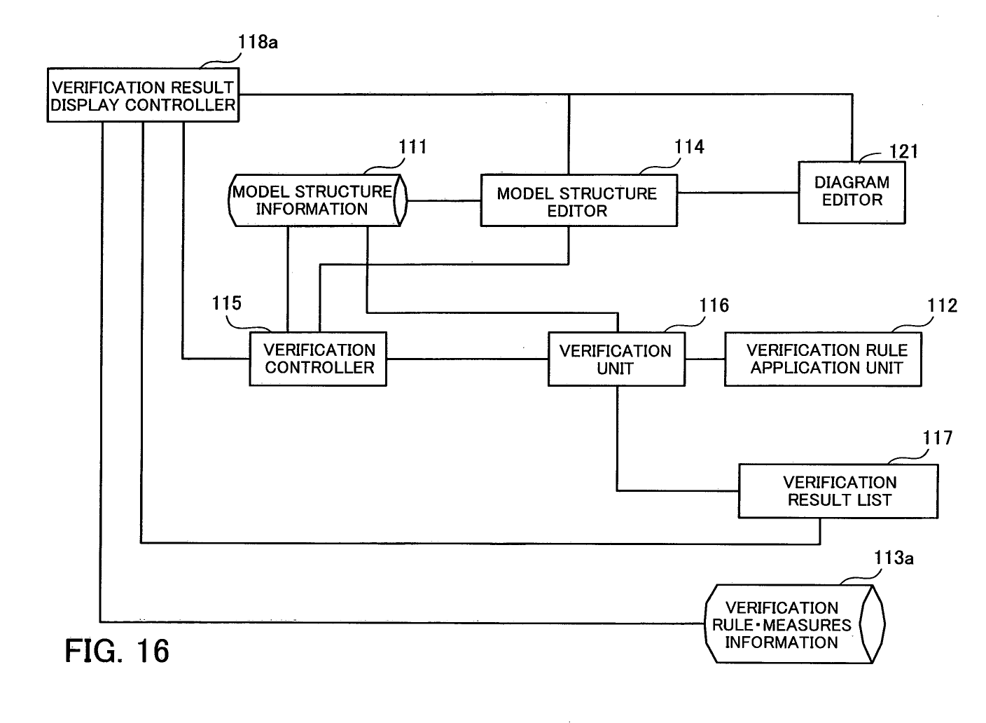

FIG. 16 is a functional block diagram according to the second embodiment. Since many functions of the second embodiment are identical to those of the first embodiment, components having identical functions to those of the first embodiment shown in FIG. 3 are given same reference numbers and will not be explained again.

Differences from the first embodiment are that a diagram editor 121 is added, verification rule-measures information 113a has modified contents, and a verification result display controller 118a has modified functions.

The diagram editor 121 creates a business process flow diagram and a data structure diagram in accordance with commands input from a user. The created diagram is input to a model structure editor 114 as a business process model.

As the diagram editor 121, general-purpose drawing software is used. However, in order to display verification error parts, API (Application Program Interface) should have been published for display of the diagram editor 121.

The verification rule-measures information 113a contains information of display place in addition to error messages and measures for verification rules. The display place is information to specify a diagram for displaying an error part. In the case where the model structure editor 114 is a display place, an error part is displayed on a diagram showing a model structure. In the case where the diagram editor 121 is a display place, an error part is displayed on a diagram showing a business process model.

The verification result display controller 118a has a function of determining a unit to which an instruction to display an error part is issued, according to the display place information set in the verification rule-measures information 113a, in addition to the functions of the verification result display controller 118 according to the first embodiment. That is, in the case where a display place is the model structure editor 114, an instruction to display an error part is output to the model structure editor 114. In the case where a display place is the diagram editor 121, an instruction to display an error part is output to the diagram editor 121.

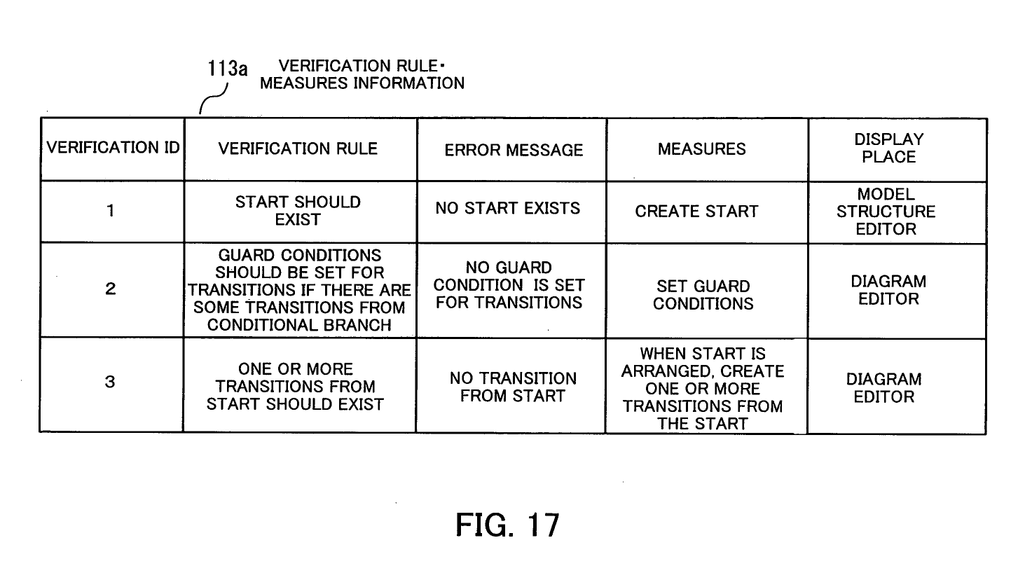

FIG. 17 is a view showing an example of verification rule-measures information according to the second embodiment. The verification rule-measures information 113a according to the second embodiment has columns for verification ID, verification rule, error message, measures and display place. The display place column contains error display places (display function) for the case where errors are detected by a verification process under corresponding verification rules.

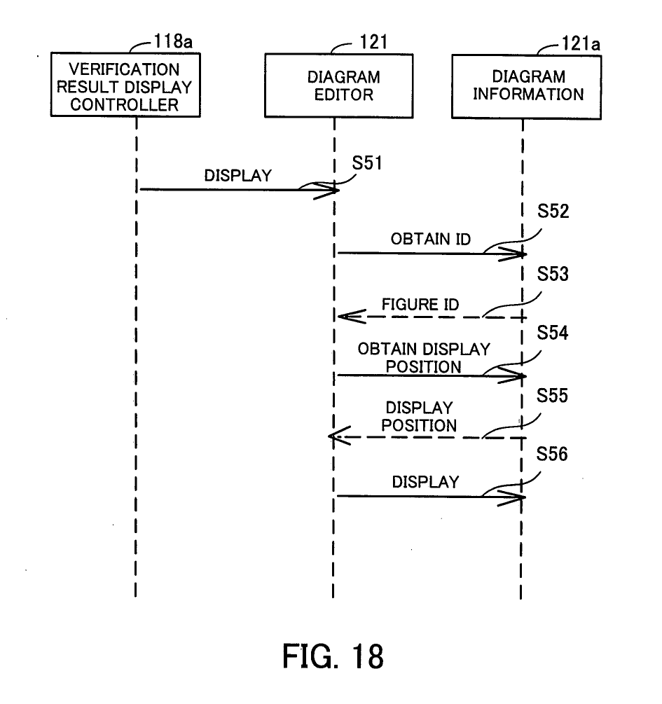

FIG. 18 is a sequence diagram showing a procedure of displaying a verification error part on an operation flow display screen.

First, the verification result display controller 118a outputs to the diagram editor 121 a display request specifying the ID of an element causing a verification error (step S51). The diagram editor 121 accesses the diagram information 121a to obtain the ID of a figure (step S52). Thereby the diagram editor 121 obtains the ID of the figure from the diagram information 121a (step S53). Then the diagram editor 121 compares the ID given in the display request with the figure ID. If the IDs do not match, the diagram editor 121 repeats a process of steps S52 and S53 until IDs match.

When IDs match, the diagram editor 121 accesses the diagram information 121a to obtain a display position of the figure corresponding to the matched ID (step S55). Thereby the diagram editor 121 obtains the position (X coordinate and Y coordinate) of the figure causing the error (step S55).

Then, the diagram editor 121 edits the diagram information 121a and arranges a figure (for example, cross mark) for error part display, at a position obtained at step S55 (step S56).

As described above, by specifying the error display position, an error can be displayed in an easy-to-understand manner. For example, by displaying an error part on the business process flow diagram being edited by the diagram editor 121, the user recognizes data to be edited to resolve the error immediately.

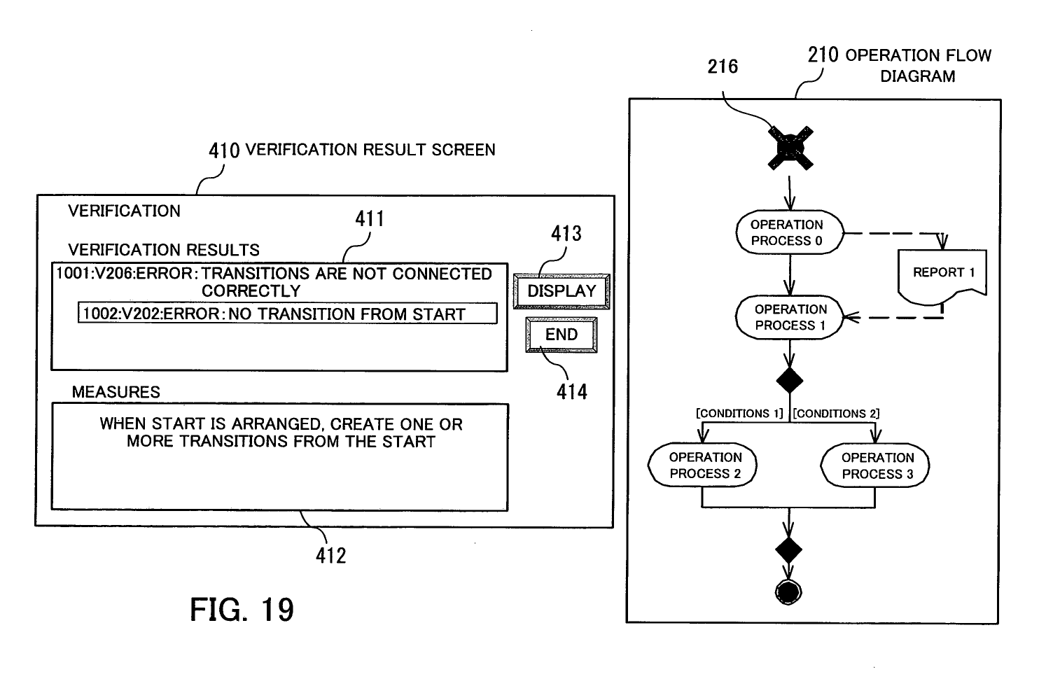

FIG. 19 is a view showing an example screen showing verification results according to the second embodiment. The example of FIG. 19 shows a display screen for the case where an error is detected under a verification rule of “one or more transitions from start should exist”. By referring to the verification rule-measures information 113a shown in FIG. 17, it is known that the error display place for the verification rule is the diagram editor 121. Therefore, a FIG. 216 that shows an error is displayed at the start position of the business process flow diagram 210 displayed by the diagram editor 121.

As described above, by performing the verification process in cooperation with the functions of the diagram editor 121, an error part can be displayed on the business process flow diagram 210 being created. Further, general-purpose drawing software can be used as the diagram editor 121, so that the business process model diagrams can be created by using user experienced software.

### Third Embodiment

Next, the third embodiment will be described. In the third embodiment, a plurality of verification rules can be selectively applied.

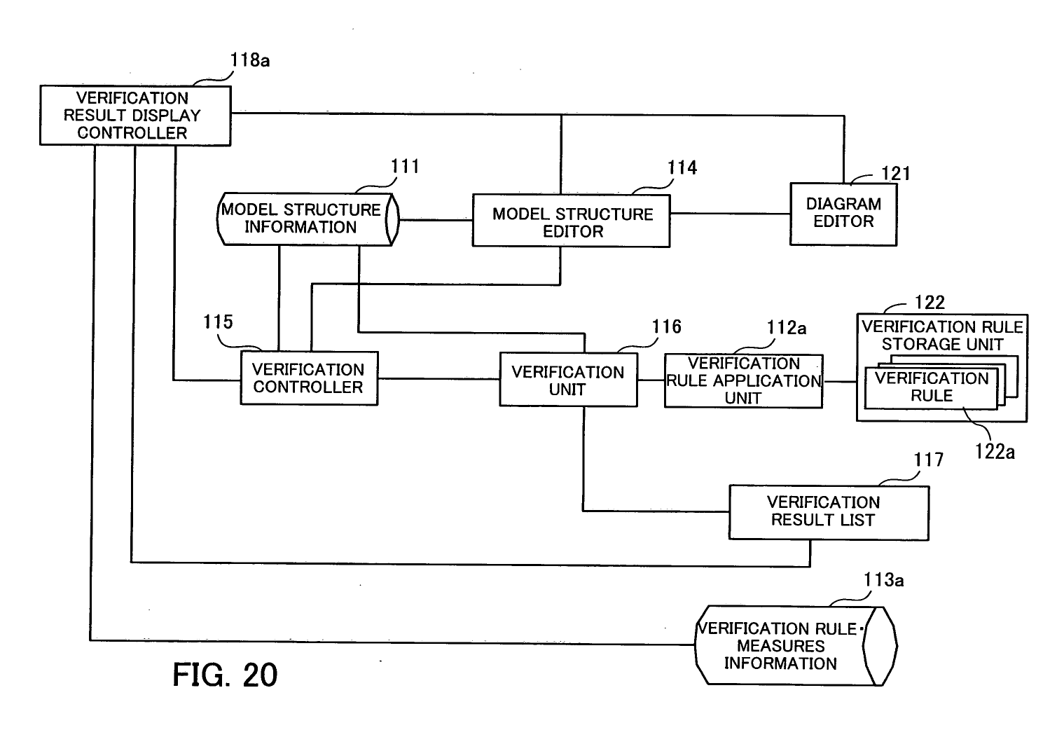

FIG. 20 is a functional block diagram according to the third embodiment. Since many functions of the third embodiment are identical to those of the second embodiment, components having identical functions to those of the second embodiment shown in FIG. 16 are given same reference numbers and will not be explained again.

Differences from the second embodiment are that a verification rule storage unit 122 is added and a verification rule application unit 112a has modified functions.

The verification rule storage unit 112 stores a plurality of verification rules 122a. In addition, to the verification rule application unit 112a, applicable verification rules are previously specified according to commands input from the user. The verification rule application unit 112a applies only applicable verification rules to perform a verification process on verification targets.

In this connection, the verification rules 122a can be implemented by using object-oriented programming language. In this case, an interface for applying the verification rules 122a is defined in super class, and the verification rules are created as its sub class. By implementing the verification rules in this way, the verification application unit 112a can read out any verification rules with the same interface by using iterator. Therefore, implementation of the verification rule application unit 112a, addition and deletion of the verification rules 122a can be easily performed.

The iterator in programming is an abstraction of a repetition process to be performed on each element in lists or similar data structure. In actual programming language, iterator appears as object or grammar. Iterator is something that is repeated.

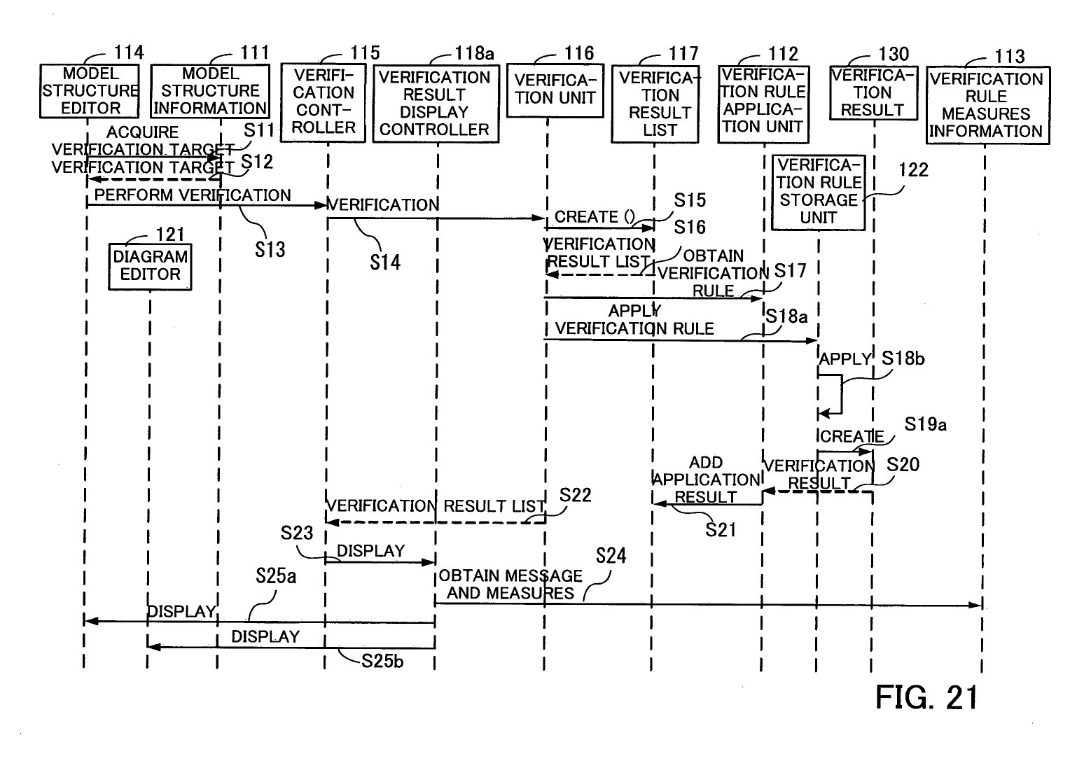

FIG. 21 is a sequence diagram showing a procedure of a business process model verification process according to the third embodiment. The processes are almost identical to those of the first embodiment shown in FIG. 12, and therefore identical processes are given same step numbers and will not be explained again. Hereinafter, different processes from the first embodiment will be described.

Processes from step S11 to step S17 are identical to those of the first embodiment. Then, the verification unit 116 gives the verification rule storage unit 122 the verification target and the verification result list, to make an instruction to apply a verification rule to the verification target (step S18a).

In the case where the verification unit 116 obtains some verification rules, the verification unit 116 outputs an instruction to apply all the obtained verification rules to the verification rule application unit 112. In addition, in the case where an obtained verification target has a lower level structure, the verification unit 116 outputs an instruction to apply all the verification rules to all verification targets including the lower level position.

The verification rule storage unit 122 applies a verification rule to a verification target every time when receiving an instruction to apply the verification rule from the verification unit 116 (step S18b). That is, in response to the instruction to apply the verification rule, the verification rule described in a program operates and a verification target is given to a process that executes the verification rule. Then the process that executes the verification rule performs judgment on the verification target.

At this time, if some verification rules are specified to apply, all the verification rules are sequentially applied to the verification target. Then by applying the verification rules (processing description by programming) stored in the verification rule storage unit 122, a verification result 130 under the verification rule is created (step S19a).

The subsequent processes from step S20 to step S24 are identical to those of the first embodiment. After the process of step S24, the verification result display controller 118a determines that the display place is the model structure editor 114 or the diagram editor 121. If the display place is the model structure editor 114, the verification result display controller 118a transmits to the model structure editor 114 an instruction to display an error part with specifying the ID of the verification target causing an error (step S25a). In this case, the model structure editor 114 displays the error part on the model structure display window 300.

If the display place is the diagram editor 121, the verification result display controller 118a transmits to the diagram editor 121 an instruction to display an error part with specifying the ID of the verification target causing an error (step S25b). In this case, the diagram editor 121 displays the error part on the business process flow diagram 210.

Thus, a set of verification rules can be easily changed. For example, verification rules can be easily changed such that only minimum verification rules are applied for a business process model for use in company, and most strict verification rules are applied for a business process model to be submitted to a customer.

### Forth Embodiment

Now, the forth embodiment will be described. In the fourth embodiment, figure information to be used by a diagram editor for display is separately stored as diagram information, and a model structure can be directly verified based on the diagram information.

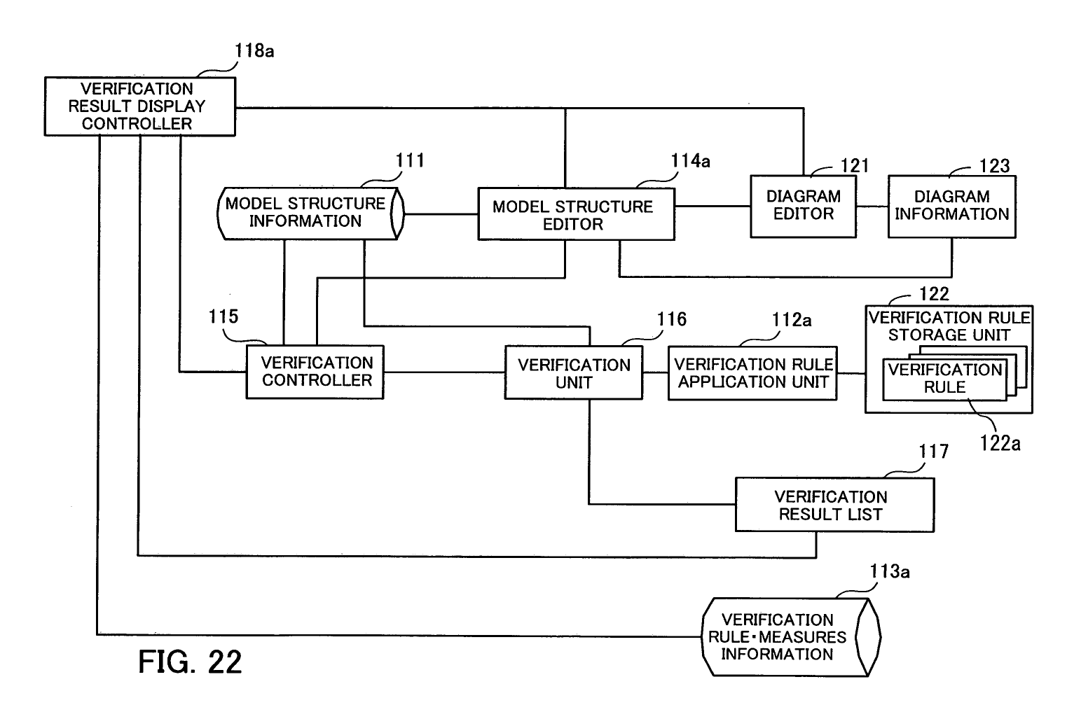

FIG. 22 is a functional block diagram according to the fourth embodiment. Since many functions of the fourth embodiment are identical to those of the third embodiment, components having identical functions to those of the third embodiment shown in FIG. 20 are given same reference numbers and will not be explained again.

Differences from the third embodiment are that diagram information 123 is provided and a verification rule application unit 112a has modified functions.

The diagram information 123 contains figure data included in a diagram representing a business process model. A model structure editor 114a analyzes the figure data included in the diagram information 123, and creates model structure information 111.

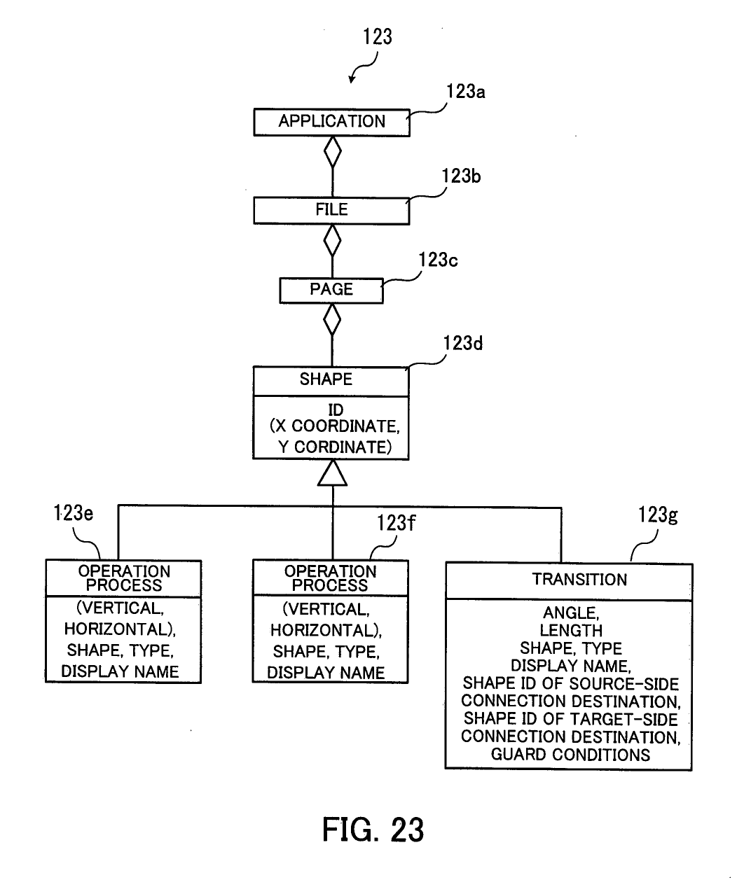

FIG. 23 is a view showing an example of diagram information. The diagram information 123 contains a plurality of figure data 123a to 123g. The figure data 123a to 123g are connected to each other in a tree structure, to thereby make up the diagram information 123. In the example of FIG. 23, individual figures are named shapes. For example, the figure data 123g for transition contains information of a shape ID of a source-side connection destination and a shape ID of a target-side connection destination.

The model structure editor 114a creates model structure information 111 based on the diagram information 123 shown in FIG. 23.

The verification rules 122a can define rules using data included in the diagram information 123. For example, such a verification rule 122a can be set that an error is determined if a shape ID of a source-side connection destination or a shape ID of a target-side connection destination is not set in the figure data 123g for transition.

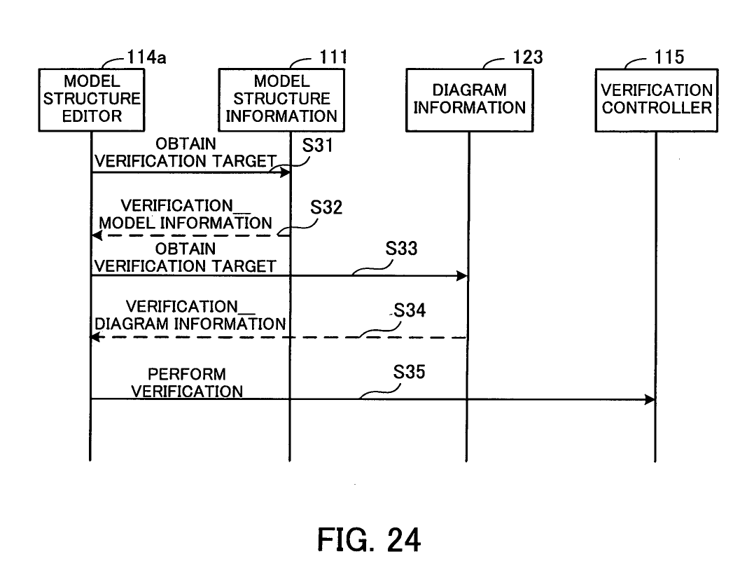

FIG. 24 is a sequence diagram showing a procedure of a business process model verification process according to the fourth embodiment. The processes of the fourth embodiment are almost the same as those of the third embodiment shown in FIG. 21, and therefore only different processes are illustrated.

The model structure editor 114a specifies a part. (verification target position) of the model structure to be verified, and performs a verification target acquisition process (step S31). Thereby, the model structure (verification_model information) to be verified is taken out of the model structure information 111 and is given to the model structure editor 114a (step S32).

Then, the model structure editor 114a specifies a part (verification target position) of diagram information to be verified, from the diagram information 123, and performs a verification target acquisition process (step S33). Thereby, the diagram information (verification_diagram information) of the verification target is taken out of the diagram information 123 and is given to the model structure editor 114a (step S34).

Then, the model structure editor 114a instructs the verification controller 115 to perform a verification process on the verification target (step S35). At this time, the verification target given to the verification controller 115 includes the verification_model information and the verification_diagram information. The subsequent processes are performed in the same way as the processes following step S15 of FIG. 21.

By performing verification based on data in the diagram information as described above, detailed verification can be performed. For example, verification can be performed based on data that is not reflected on the model structure information 111.

### Fifth Embodiment

Now, the fifth embodiment will be described. In the fifth embodiment, verification result lists are stored as a result of some verification processes employing different conditions such as execution time, and a progress of creating a business process model can be measured. In addition, in the fifth embodiment, an importance level is set for a verification rule, and when a verification error is detected, the importance level is displayed together with an error message.

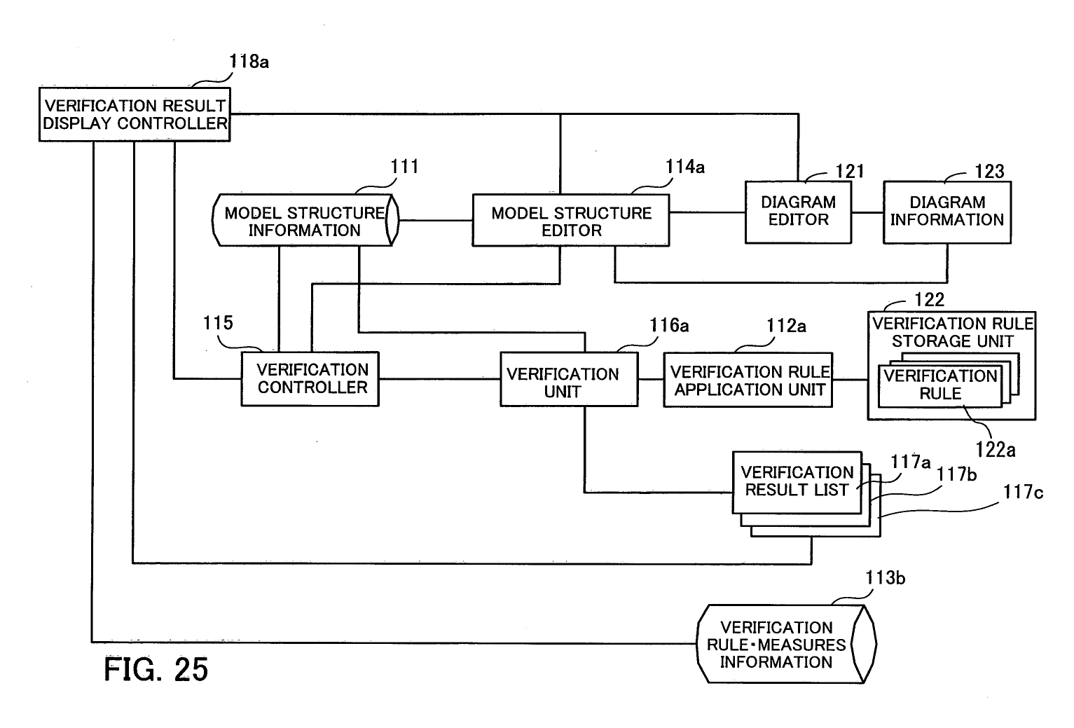

FIG. 25 is a functional block diagram according to the fifth embodiment. Since many functions of the fifth embodiment are identical to those of the fourth embodiment, components having identical functions to those of the fourth embodiment shown in FIG. 22 are given same reference numerals and will not be explained again.

Differences from the fourth embodiment are that a plurality of verification result lists 117a, 117b, and 117c can be stored, a verification unit 116a and a verification result display controller 118a have modified functions, and verification rule-measures information 113b have modified contents.

The verification unit 116a performs a verification process, and creates a verification result list with a timestamp (information showing a current time). When a verification process is performed on a business process model some times in a process of creating the business process model, a plurality of verification result lists 117a, 117b, and 117c with different timestamps are created.

The verification result display controller 118a creates statistical data indicating a progress of creating the business process model by using the plurality of verification result lists 117a, 117b, and 117c, and displays the data on a screen.

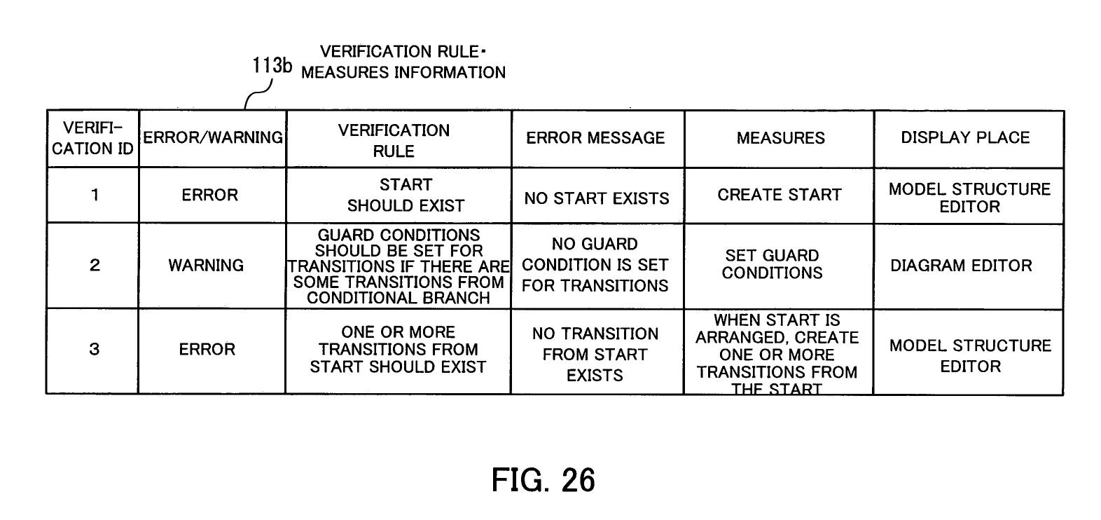

FIG. 26 is a view showing an example data structure of the verification rule-measures information. This verification rule-measures information 113b has columns for verification ID, error/warning, verification rule, error message, measures, and display place. Compared with the verification rule-measures information 113a of FIG. 17, an error/warning column is added.

The error/warning column contains importance levels of errors when verification target elements do not satisfy corresponding verification rules. In the example of FIG. 26, “error” and “warning” are used as the importance levels, and the error has a higher importance level. For example, “error” is set for a verification rule that has to be satisfied, while “warning” is set for a verification rule that is desired to be satisfied.

An importance level is displayed together with an error message when a verification error is detected under a corresponding verification rule. In addition, the importance level is used as a basis of statistical information indicating a progress.

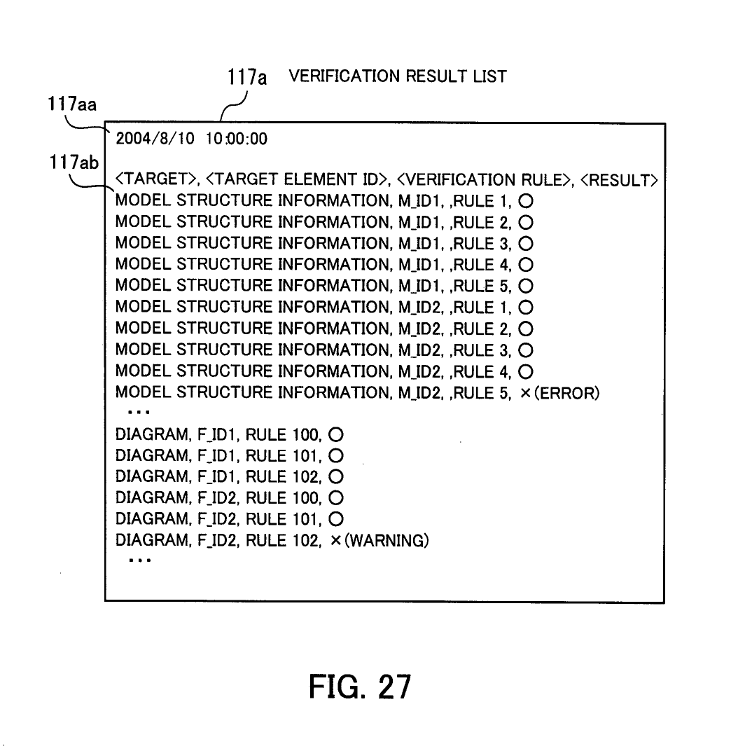

FIG. 27 is a view showing an example verification result list having a timestamp given thereto. The verification result list 117a contains a timestamp 117aa and verification results 117ab.

The timestamp 117aa indicates a creation date and time of the verification result list 117a. The verification results 117ab contain sets of a target, a target element ID, a verification rule, and a result. The target indicates as a verification target, the model structure information 111 or the diagram information 123 (indicated by “diagram” in the verification result list 117a, simply). The target element ID, verification rule, and result are identical to those in the example of the first embodiment of FIG. 13.

It should be noted that result information includes importance level information (error/warning) for a case where a verification error is detected (result “x”).

Based on the plurality of verification result lists 117a, 117b, and 117c with timestamps, the number of errors and the number of warnings can be counted as statistical information. The statistical result is displayed as a progress on a screen.

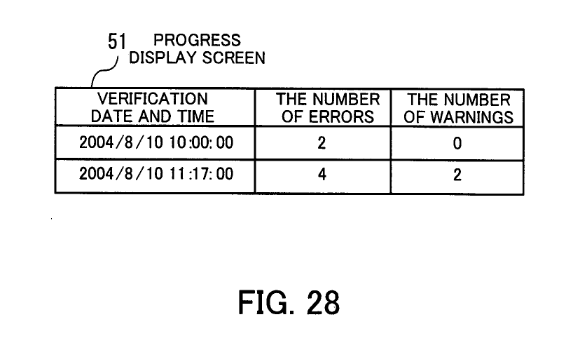

FIG. 28 is a view showing the first example of a screen displaying a progress. The progress display screen 51 has columns for verification date and time, the number of errors, and the number of warnings, and verification results are displayed in time series.

By checking the change in the number of errors and the number of warnings, the progress of creating a business process model can be estimated. For example, when the number of errors and the number of warnings are decreasing, it can be assumed that the operation of creating the business process model is in the final stage (error correction stage), and the operation is going fine.

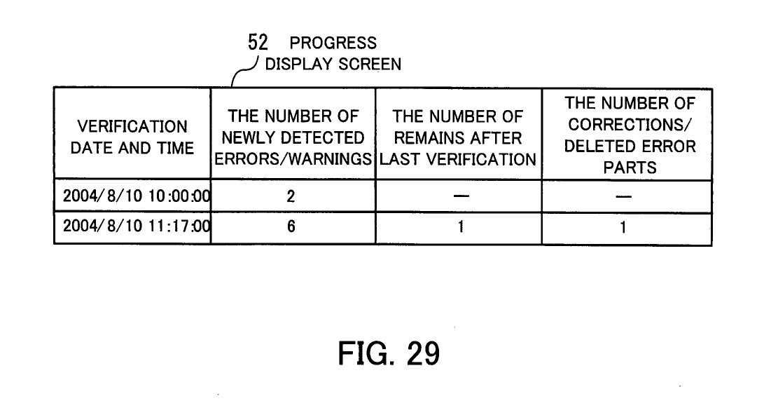

FIG. 29 is a view showing the second example of a progress display screen. This progress display screen 52 has columns for verification date and time, the number of newly detected errors/warnings, the number of remains after last verification, and the number of corrections/deleted error parts. Verification results are displayed in time series.

The number of newly detected errors/warnings indicates the number of new errors and warnings that were not detected by the last verification process. The number of remains after last verification indicates the number of unprocessed errors and warnings out of the errors and warnings detected by the last verification process. The number of corrections/deleted error parts indicates the number of errors and warnings corrected or deleted after the last verification process and before this time verification process.

It can be determined whether errors and warnings detected by the last verification process are detected by the this time verification process, depending on whether targets, target element IDs, and verification rules in the verification result lists match or not.

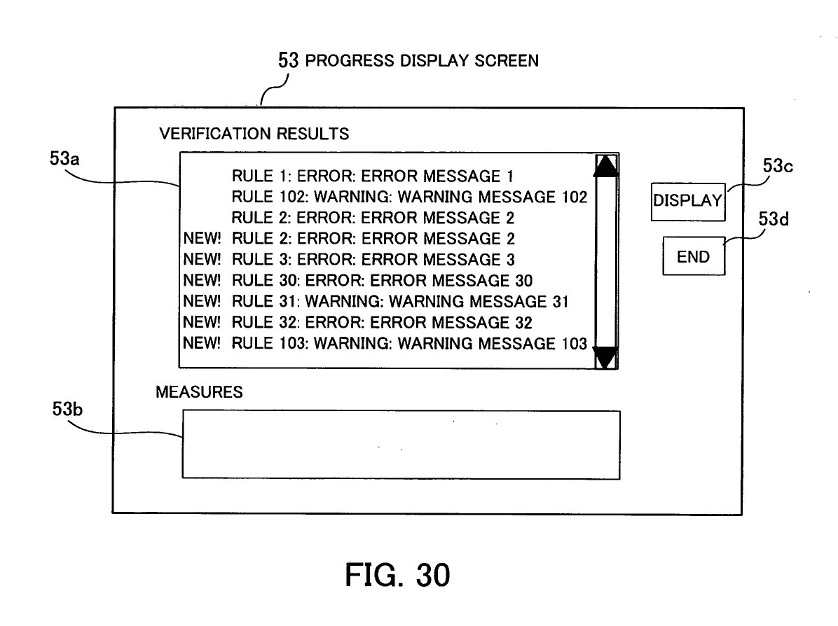

FIG. 30 is a view showing the third example of a progress display screen. This progress display screen 53 has a verification result display area 53a, a measures display area 53b, a display button 53c, and an end bottom 53d.

The verification result display area 53a displays a list of verification errors (errors and warnings) detected so far. Verification errors newly detected by the last verification process are given a mark (“New!” in the example of FIG. 30) that shows a new error.

The user can select a verification error to be checked for more details, on the verification result display area 53a. In this connection, errors and warnings already corrected are displayed in gray and are not selectable.

The measures display area 53b displays measures for a verification error selected on the verification result display area 53a. The display button 53c is a button for displaying a part causing a verification error selected on the verification result display area 53a. The end button 53d is a button for closing the progress display screen 53.

As described above, verification results are displayed such that verification errors (with a mark “New!”) occurring after the last verification, verification errors (in gray letters) already corrected after the last verification and before this time verification, and verification errors (in black letters, and without mark “New!”) detected in the last verification but not corrected yet can be displayed in different way.

### Sixth Embodiment

Now, the sixth embodiment will be described. In the sixth embodiment, information specifying verification rules to be applied and verification rules not to be applied, out of a plurality of verification rules is registered in a use verification rule setting file, and by selecting the use verification rule setting file at the time of a verification process, the verification rules to be applied are specified.

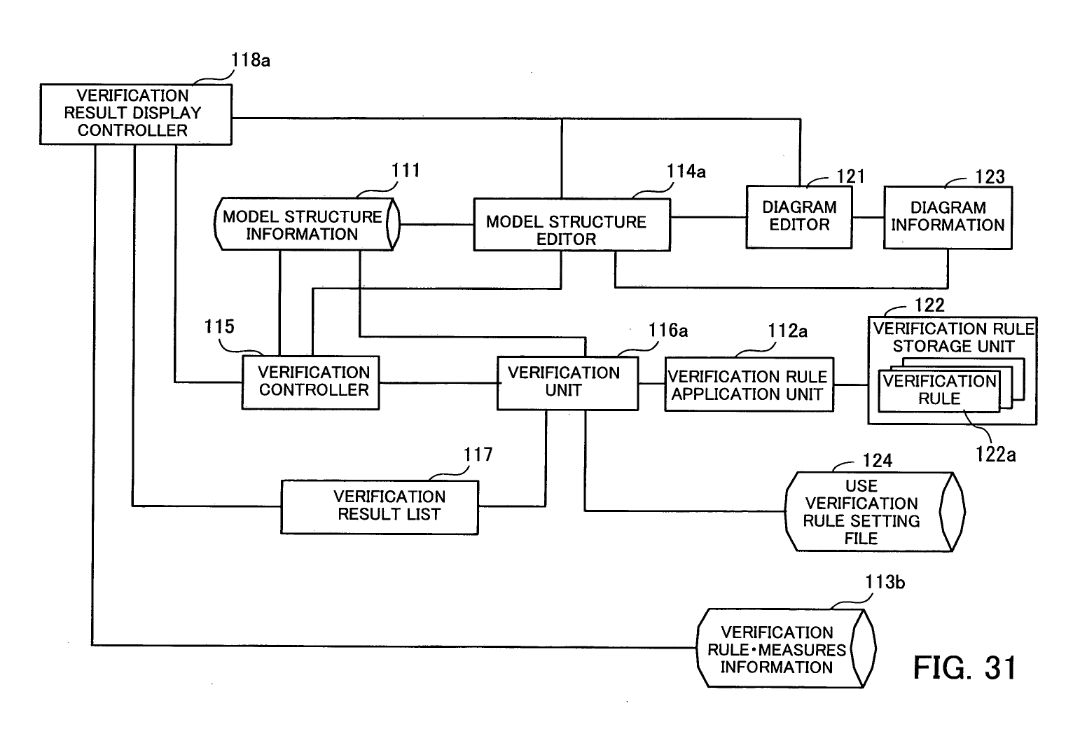

FIG. 31 is a functional block diagram according to the sixth embodiment. Since many functions of the sixth embodiment are identical to those of the fifth embodiment, components having identical functions to those of the fifth embodiment of FIG. 25 are given same reference numerals and will not be explained again.

Differences from the fifth embodiment are that a use verification rule setting file 124 is newly provided and a verification unit 116a has modified functions.

The use verification rule setting file 124 describes the numbers of verification rules selected by an operation modeler, separately with commas. The verification unit 116a performs a verification process by using only verification rules of the numbers described in the use verification rule setting file 124 out of verification rules 122a stored in a verification rule storage unit 122.

In addition, a plurality of use verification rule setting files 124 can be prepared. In this case, the verification unit 116a is provided with a function of setting the name of a use verification rule setting file 124. Then, the verification unit 116a outputs an instruction of the verification process to a verification rule application unit 112a based on the use verification rule setting file 124 corresponding to a preset name. Thus, the operation modeler can set a setting file appropriate for his/her purposes, out of a plurality of setting files, so as to perform a verification process.

### Other Applications

Now, example applications applicable to above embodiments will be described. Hereinafter, it is assumed that each application is applied to the system according to the sixth embodiment, and will be described with reference to the configuration shown in FIG. 31.

First, the first application example will be described. In the first application example, timing of verification process is preset, and the verification process is automatically performed at the preset timing. In this case, for example, verification timing is set in the verification rule-measures information 113b, and the verification controller 115 manages the verification timing of each verification rule, based on the verification rule-measures information 113b.

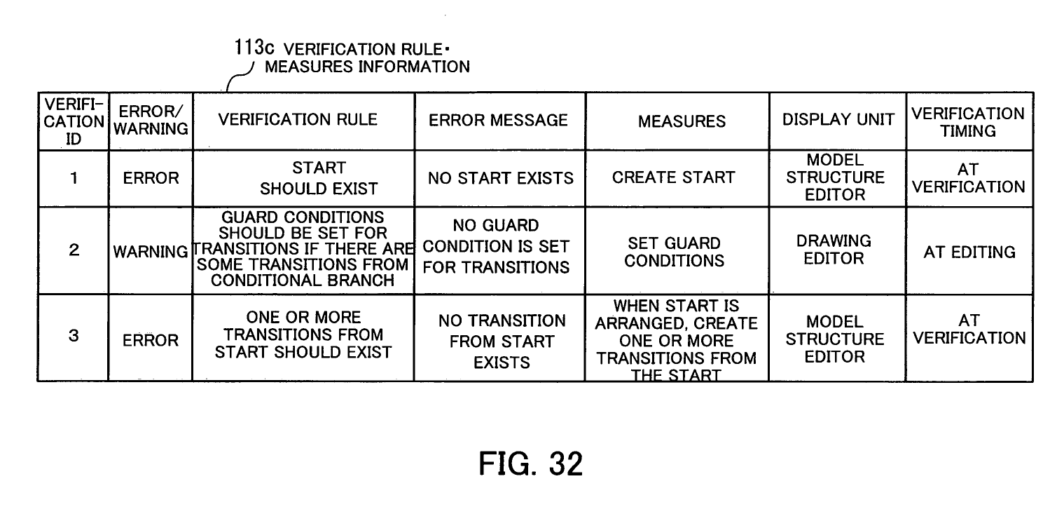

FIG. 32 is a view showing an example of verification rule-measures information with verification timing set therein. This verification rule-measures information 113c has columns for verification ID, error/warning, verification rule, error message, measures, display place, and verification timing. Compared with the verification rule-measures information 113b shown in FIG. 26, the verification timing column is added.

The verification timing indicates timing for applying a corresponding verification rule. If the verification timing is “at verification”, a verification process is performed under a corresponding verification rule when a command to do so is made from a user.

Further, if the verification timing is “at editing”, a verification process is performed under a corresponding verification rule every time when a figure is entered by the diagram editor 121 while the user edits a business process model. Specifically, when a figure is entered by the diagram editor 121 and setting for the figure such as a position is fixed, its information is given to the model structure editor 114a. For example, when an operation for another figure starts, the setting for a figure operated until this time is assumed to be fixed.

Alternatively, verification timing can be set such that verification is performed at prescribed intervals, or verification is performed when a file is saved or closed.

Specifically, the model structure editor 114a updates the model structure information 111 every time when a new figure is entered, and notifies the verification controller 115 of the updating. Then, the verification controller 115 outputs an instruction to verify the newly entered element to the verification unit 116a.

The verification unit 116a refers to the verification rule-measures information 113c, to specify a verification rule that is applicable to the entered element at verification timing of “at editing”. Then the verification unit 116a outputs an instruction to apply the verification rule to the verification rule application unit 112a.

As described above, the verification process can be automatically performed. Thereby the user can immediately know an error when he/she makes the error such as an erroneous arrangement of a figure.

Now, the second application example will be described. In the second application example, a user can define desired verification rules. For example, the business process flow diagram creation supporting apparatus is newly provided with a verification rule reader for reading verification rules stored in a certain location. The user inputs the name of a file containing verification rules to be applied, to the verification rule reader when performing a verification process. Then the verification rule reader registers the verification rules stored in the specified file in the verification rule storage unit 122. For example, the user can set the verification rules with the OCL (Object Constraint Language).

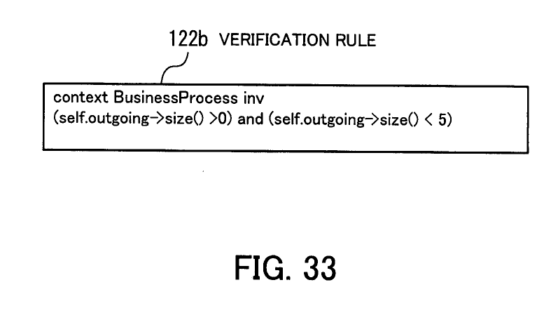

FIG. 33 is a view showing an example verification rule that is desirably set. The verification rule 122b defines that the number of lines that are output from an element indicated by “context BusinessProcess inv” should be greater than zero and less than five.

Such a verification rule 122b is used for limiting the number of connectable lines because too many lines cause complexity in a structure such as an operation flow even if possible.

Now, the third application example will be described. In the third application example, measures are automatically taken when an error is detected. In this case, for example, model patterns before measures and model patterns after measures are registered in the verification rule-measures information 113b.

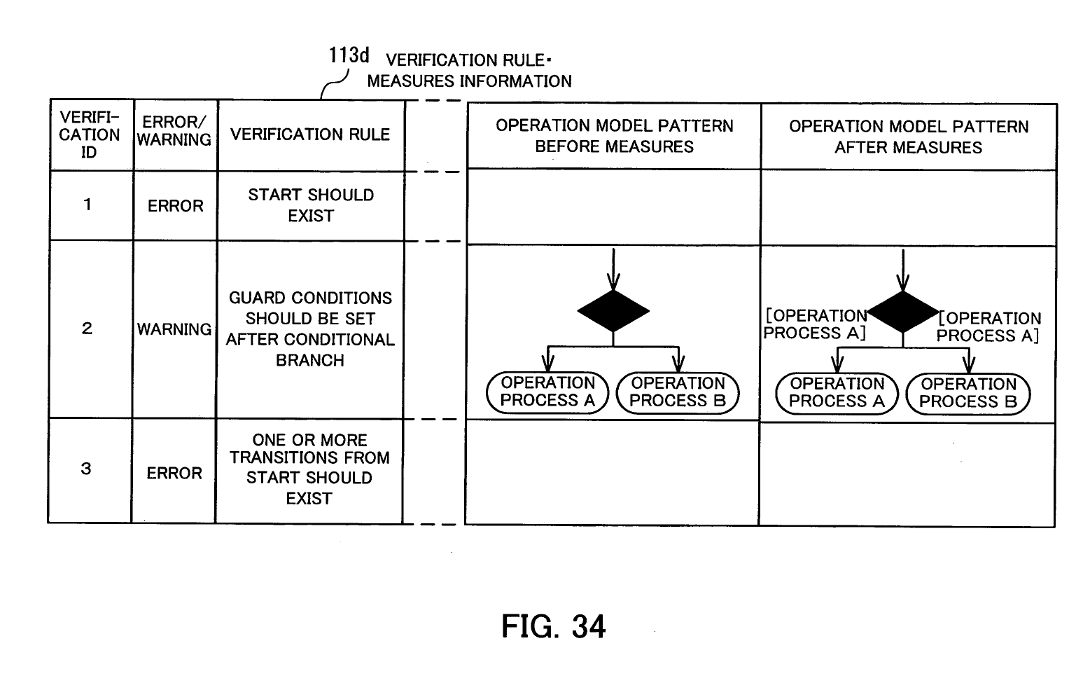

FIG. 34 is a view showing an example of verification rule-measures information with model patterns before and after measures registered therein. This verification rule-measures information 113d has columns for business process model pattern before measures and business process model pattern after measures, in association with verification rule.

A business process model pattern before measures shows a pattern of business process model that causes an error. A business process model pattern after measures shows a pattern of business process model that can resolve the error.

By defining such patterns, if the structure of a verification error part matches a model pattern before measures, the structure can be changed to the model after measures that is then displayed. For example, the verification rule of the verification ID “2” in FIG. 34 defines a business process model pattern after measures, for modifying an operation flow by giving guard conditions for the case where the guard conditions are not set for branch destinations of decision/merge node.

In this connection, in the example of FIG. 34, the names of business processes of transition destinations are automatically set as guard conditions. If the user thinks that different guard conditions are appropriate, the user can make a command to the diagram editor 121 for setting desired guard conditions.

When a verification error is detected, the verification result display controller 118a refers to the verification rule-measures information 113d, and if the information 113d includes a business process model pattern before measures and a business process model pattern after measures, outputs an instruction to change a model according to the set contents to the diagram editor 121. The diagram editor 121 edits a diagram such as a business process flow diagram in accordance with the instruction.

It should be noted that, when a business process model pattern before measures is automatically edited to a business process model pattern after measures, the diagram after editing may be fixed by a user command indicating approval. This allows the user to always confirm a changed diagram.

The processing functions described above can be realized by a computer. In this case, a program is prepared, which describes processes for the functions to be performed by the business process model diagram creation supporting apparatus. The program is executed by a computer, whereupon the aforementioned processing functions are accomplished by the computer. The program describing the required processes may be recorded on a computer-readable recording medium. Computer-readable recording media include magnetic recording devices, optical discs, magneto-optical recording media, semiconductor memories, etc. The magnetic recording devices include Hard Disk Drives (HDD), Flexible Disks (FD), magnetic tapes, etc. The optical discs include Digital Versatile Discs (DVD), DVD-Random Access Memories (DVD-RAM), Compact Disc Read-Only Memories (CD-ROM), CD-R (Recordable)/RW (ReWritable), etc. The magneto-optical recording media include Magneto-Optical disks (MO) etc.

To distribute the program, portable recording media, such as DVDs and CD-ROMs, on which the program is recorded may be put on sale. Alternatively, the program may be stored in the storage device of a server computer and may be transferred from the server computer to other computers through a network.

A computer which is to execute the program stores in its storage device the program recorded on a portable recording medium or transferred from the server computer, for example. Then, the computer runs the program. The computer may run the program directly from the portable recording medium. Also, while receiving the program being transferred from the server computer, the computer may sequentially run this program.

According to the present invention, the type of each constituent element forming a business process model diagram 1 is determined, verification is performed under a verification rule relevant to the type, and if a dissatisfaction result is obtained, a position to be operated to resolve the dissatisfaction is displayed. This allows a user to easily correct defects in the business process model created by using general-purpose drawing software.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable recording medium containing a business process model diagram creation supporting program for supporting creation of a business process model diagram representing a structure of user's business process model, the program causing a computer to function as:
model structure analysis means for analyzing the business process model diagram where figures and lines are used as constituent elements, determining a type of each constituent element forming the business process model diagram, and creating a model structure representing relations between the constituent elements;
verification means for selecting at least part of the constituent elements as a verification target element, extracting a verification rule relevant to the type of the verification target element selected, out of preset verification rules describing conditions that the constituent elements of the business process model diagram should satisfy, and verifying whether the verification target element selected satisfies the extracted verification rule; and
verification result display means for displaying a position to be operated to resolve dissatisfaction of the verification target element with the verification rule in a case where the verification means obtains a dissatisfaction result.

2. The computer-readable recording medium according to claim 1, wherein, in the case where the verification means obtains the dissatisfaction result, the verification result display means refers to measures information describing measures and displays the measures for modifying the verification target element to satisfy the verification rule that has not been satisfied, the measures indicating how to modify the constituent elements that do not satisfy the verification rules to satisfy the verification rules.

3. The computer-readable recording medium according to claim 1, wherein the verification result display means displays a position of the verification target element on a diagram representing the model structure of the business process model diagram.

4. The computer-readable recording medium according to claim 1, wherein the verification result display means displays on the business process model diagram a position of the verification target element in terms of the business process model diagram.

5. The computer-readable recording medium according to claim 1, wherein the verification means applies the verification rule specified by a user out of a plurality of the verification rules previously stored, to the verification target element.

6. The computer-readable recording medium according to claim 1, wherein the verification means verifies whether the verification target element satisfies the verification rule when verification timing preset for the verification rule comes.

7. The computer-readable recording medium according to claim 1, wherein the verification means verifies the verification target element by using the verification rule that directly verifies data defining the constituent elements of the business process model diagram.

8. The computer-readable recording medium according to claim 1, wherein the verification result display means displays an importance level of dissatisfaction with the verification rule, together with an error message in the case where the verification means obtains the dissatisfaction result.

9. The computer-readable recording medium according to claim 1, wherein:
the verification means accumulates verification results with timestamps given thereto, in memory means; and
the verification result display means creates and displays statistical information showing a shift in an error state where the constituent elements are determined not to satisfy the verification rules, on a basis of the verification results accumulated in the memory means.

10. The computer-readable recording medium according to claim 1, wherein the verification means verifies the verification target element under the verification rule desirably defined by a user.

11. The computer-readable recording medium according to claim 1, wherein, in a case where the verification rule includes a changed pattern for modifying the verification target element that does not satisfy the verification rule, to satisfy the verification rule, and the verification means obtains the dissatisfaction result, the verification result display means displays the business process model diagram with the verification target element changed according to the changed pattern.

12. The computer-readable recording medium according to claim 1, wherein the verification means has a plurality of verification rule groups including a plurality of the verification rules, applies the verification rule included in a verification rule group selected by a user, to the verification target element, to determine satisfaction or dissatisfaction.

13. A business process model diagram creation supporting method for supporting creation of a business process model diagram representing a structure of user's business process model by using a computer, wherein:
model structure analysis means analyzes the business process model diagram where figures and lines are used as constituent elements, determines a type of each constituent element forming the business process model diagram, and creates a model structure representing relations between the constituent elements;
verification means selects at least part of the constituent elements as a verification target element, extracts a verification rule relevant to the type of the verification target element selected, out of preset verification rules describing conditions that the constituent elements of the business process model diagram should satisfy, and verifies whether the verification target element selected satisfies the extracted verification rule; and
verification result display means displays a position to be operated to resolve dissatisfaction of the verification target element with the verification rule in a case where the verification means obtains a dissatisfaction result.

14. A business process model diagram creation supporting apparatus for supporting creation of a business process model diagram representing a structure of user's business process model, comprising:
model structure analysis means for analyzing the business process model diagram where figures and lines are used as constituent elements, determining a type of each constituent element forming the business process model diagram, and creating a model structure representing relations between the constituent elements;
verification means for selecting at least part of the constituent elements as a verification target element, extracting a verification rule relevant to the type of the verification target element selected, out of preset verification rules describing conditions that the constituent elements of the business process model diagram should satisfy, and verifying whether the verification target element selected satisfies the extracted verification rule; and
verification result display means for displaying a position to be operated to resolve dissatisfaction of the verification target element with the verification rule in a case where the verification means obtains a dissatisfaction result.
